(19) United States
(12) Patent Application Publication
(10) Pub. No.: US 2026/0147597 A1
(43) Pub. Date: May 28, 2026

(54) OPERATION SUPPORT SYSTEM, OPERATION SUPPORT METHOD, AND INFORMATION STORAGE MEDIUM

(71) Applicant: Cybozu, Inc., Tokyo (JP)

(72) Inventors: Sebastien BREUILLES, Saitama-shi (JP); Ryosuke OSHIDA, Berkeley, CA (US); Hideki IGARASHI, Yokohama-shi (JP); Hayato SHIMOJI, Ichinomiya-shi (JP); Ryu YAMASHITA, Fukuoka-shi (JP); Yoshinori SANO, Tokyo (JP)

(21) Appl. No.: 19/402,956

(22) Filed: Nov. 26, 2025

(30) Foreign Application Priority Data
Nov. 27, 2024 (JP) 2024-206312

(51) Int. Cl. G06F 9/451; H04L 51/04

(52) U.S. Cl. CPC G06F 9/453; H04L 51/04

(57) ABSTRACT

Provided is an operation support system including at least one processor configured to: acquire work information relating to a work screen on which an operation relating to work of a user is defined, the work screen being displayed on a user terminal of the user; acquire, based on the work information and an artificial intelligence (AI), operation support information relating to support for the operation on the work screen; and provide the operation support information to the user.

### CROSS-REFERENCE TO RELATED APPLICATION

The present disclosure contains subject matter related to that disclosed in Japanese Patent Application JP 2024-206312 filed in the Japan Patent Office on Nov. 27, 2024, the entire contents of which are hereby incorporated by reference.

### BACKGROUND OF THE INVENTION

### 1. Field of the Invention

The present disclosure relates to an operation support system, an operation support method, and an information storage medium.

### 2. Description of the Related Art

Hitherto, a work screen on which operations relating to work of a user are defined has been known. For example, in Japanese Patent No. 6830218, there is described a cloud-type information processing system that displays various work screens on a user terminal of a user. In the information processing system of Japanese Patent No. 6830218, a help page relating to an operation method for each work screen is prepared. When the user of Japanese Patent No. 6830218 does not understand an appropriate operation on the work screen, the user searches the help page to find the appropriate operation.

### SUMMARY OF THE INVENTION

However, the technology of Japanese Patent No. 6830218 has required a user to search the help page to find an appropriate operation when the user does not understand the appropriate operation on the work screen, thereby imposing time and effort on the user. This point is not limited to the cloud-type information processing system such as that described in Japanese Patent No. 6830218. This point applies to technologies in general that provide a work screen to a user. The related-art technologies have failed to reduce time and effort of a user.

One object of the present disclosure is to reduce time and effort of a user.

According to at least one aspect of the present disclosure, there is provided an operation support system including at least one processor configured to: acquire work information relating to a work screen on which an operation relating to work of a user is defined, the work screen being displayed on a user terminal of the user; acquire, based on the work information and an artificial intelligence (AI), operation support information relating to support for the operation on the work screen; and provide the operation support information to the user.

### BRIEF DESCRIPTION OF THE DRAWINGS

FIG. 1 is a diagram for illustrating an example of a hardware configuration of an operation support system.

FIG. 2 is a view for illustrating an example of a screen displayed on a user terminal.

FIG. 3 is a view for illustrating an example of screens displayed on the user terminal.

FIG. 4 is a diagram for illustrating an example of functions implemented in the operation support system.

FIG. 5 is a diagram for illustrating an example of AI inputs and an AI output.

FIG. 6 is a flowchart for illustrating an example of processing executed in the operation support system.

FIG. 7 is a diagram for illustrating an example of functions implemented in an operation support system according to modification examples.

FIG. 8 is a diagram for illustrating an example of AI inputs and an AI output in Modification Example 1.

FIG. 9 is a diagram for illustrating an example of AI inputs and an AI output in Modification Example 2.

FIG. 10 includes a view for illustrating an example of an error that has occurred on a work screen and a diagram for illustrating an example of AI inputs and an AI output in Modification Example 4.

FIG. 11 is a diagram for illustrating an example of AI inputs and an AI output in Modification Example 5.

FIG. 12 includes a view for illustrating an example of an online-chat screen and a diagram for illustrating an example of AI inputs and an AI output in Modification Example 7.

FIG. 13 is a view for illustrating an example of an online-chat screen in Modification Example 8.

FIG. 14 is a diagram for illustrating an example of AI inputs and an AI output in Modification Example 9.

FIG. 15 is a diagram for illustrating an example of AI inputs and an AI output in Modification Example 10.

FIG. 16 is a diagram for illustrating an example of AI inputs and an AI output in Modification Example 11.

FIG. 17 is a diagram for illustrating an example of AI inputs and an AI output in Modification Example 12.

### DESCRIPTION OF THE EMBODIMENTS

### 1. Hardware Configuration

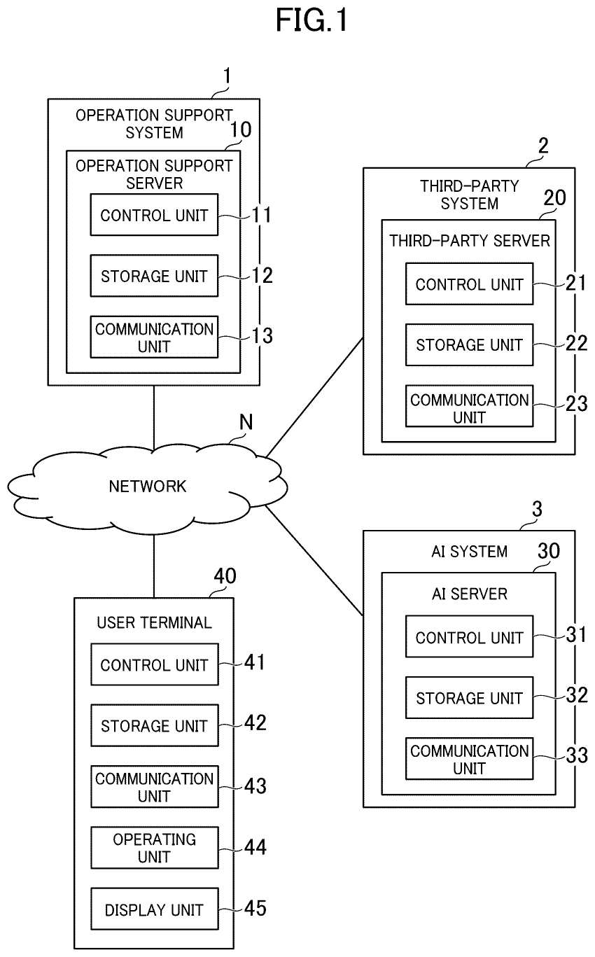

An example of an operation support system, an operation support method, and a program according to at least one embodiment of the present disclosure is described. FIG. 1 is a diagram for illustrating an example of a hardware configuration of the operation support system. For example, an operation support system 1 includes an operation support server 10. The operation support system 1 is connected to a network N such as the Internet or a LAN. In the at least one embodiment, a case in which a third-party system 2, an artificial intelligence (AI) system 3, and a user terminal 40 are also connected to the network N is taken as an example.

The operation support server 10 is a server computer for an operation support service described later. For example, the operation support server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

A program stored in the storage unit 12 may be supplied to the operation support server 10 through the network N. A hardware configuration of the operation support server 10 is not limited to the example of FIG. 1. For example, the operation support server 10 may include at least one of a reading unit (for example, a memory card slot) that reads a computer-readable information storage medium or an input/output unit (for example, a USB terminal) for directly connecting to an external device. A program stored in the information storage medium may be supplied to the operation support server 10 through at least one of the reading unit or the input/output unit.

Moreover, the operation support system 1 is only required to include at least one computer. The computers included in the operation support system 1 are not limited to the example of FIG. 1. For example, the operation support system 1 may include the operation support server 10 and another computer. The operation support system 1 may include, as the another computer, at least one of a third-party server 20, an AI server 30, or the user terminal 40.

The third-party system 2 is a system for a work support service described later. The third-party system 2 is a system different from the operation support system 1. In the at least one embodiment, a case in which the third-party system 2 is managed by a third party different from a party who manages the operation support system 1 is taken as an example. For example, the third-party system 2 includes the third-party server 20. The third-party server 20 is a server computer for the work support service described later. The third-party server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The AI system 3 is a system for an AI service described later. The AI system 3 is a system different from the operation support system 1. The AI system 3 is also different from the third-party system 2. In the at least one embodiment, a case in which a party who manages the AI system 3 is different from any one of the party who manages the operation support system 1 or a party who manages the third-party system 2 is taken as an example. For example, the AI system 3 includes the AI server 30. The AI server 30 is a server computer for the AI service described later. The AI server 30 includes a control unit 31, a storage unit 32, and a communication unit 33. Hardware configurations of the control unit 31, the storage unit 32, and the communication unit 33 may be the same as those of the control unit 11, the storage unit 12, and the communication unit 13, respectively.

The user terminal 40 is a computer of a user. For example, the user terminal 40 is a personal computer, a tablet terminal, a smartphone, or a wearable terminal. The user terminal 40 includes a control unit 41, a storage unit 42, a communication unit 43, an operating unit 44, and a display unit 45. Hardware configurations of the control unit 41, the storage unit 42, and the communication unit 43 may be the same as those of the control unit 11, the storage unit 12, and the communication unit 13, respectively. The operating unit 44 is an input device such as a mouse or a touch panel. The display unit 45 is a liquid crystal display or an organic EL display.

### 2. Overview of Operation Support System

In the at least one embodiment, a case in which the third-party system 2 provides the work support service to users is taken as an example. The work support service is a service that supports work of each user. The work support service may be a service classified as groupware, or may be a service not particularly classified as groupware. The work support service may be a cloud-based service or an on-premises service. The work support service may support work of each user belonging to an organization, or may support work of a user who is an individual. The organization can also be said to be a group to which a plurality of users belong. For example, the organization is a company or a government agency.

In the at least one embodiment, a case in which a user belonging to an organization uses the work support service is taken as an example. The organization to which the user belongs contracts with the work support service. The user uses the work support service as a member of the organization. In the at least one embodiment, expense reimbursement work is taken as an example of work supported by the work support service, but the work support service can support various kinds of work in the organization. When the user operates the user terminal 40 to log in to the work support service, the user terminal 40 displays a screen for supporting the work of the user on the display unit 45.

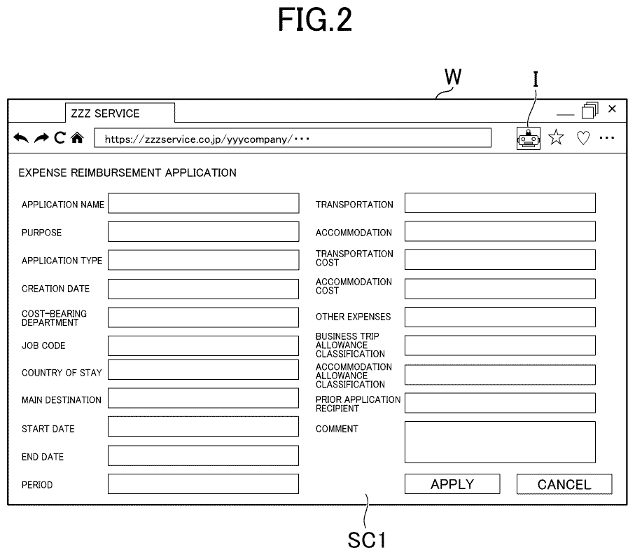

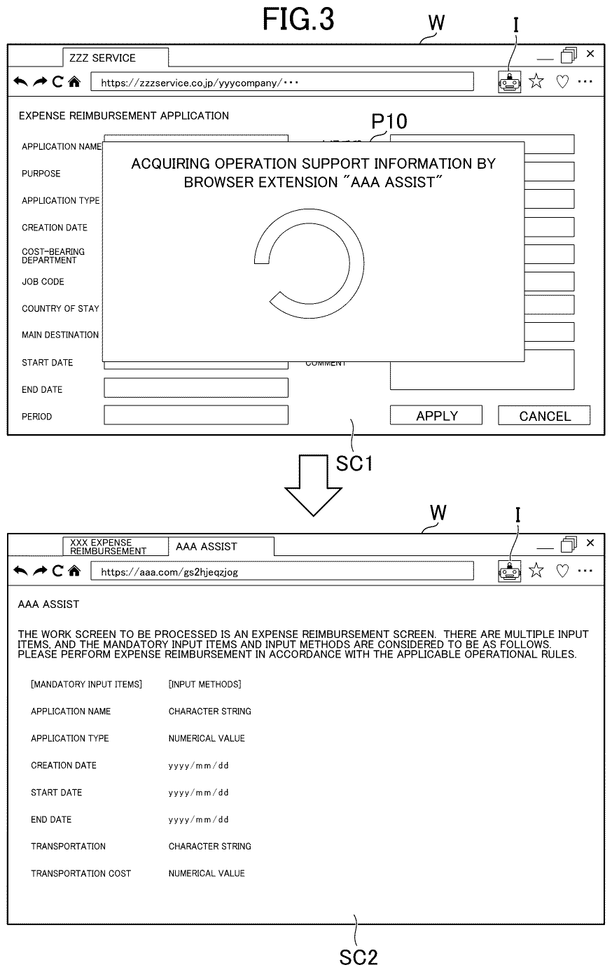

FIG. 2 and FIG. 3 are views for illustrating examples of screens displayed on the user terminal 40. In the at least one embodiment, a case in which each screen is displayed by a browser of the user terminal 40 is taken as an example, but each screen may be displayed by another program (for example, a program dedicated to the work support service) other than the browser. In the example of FIG. 2, a work screen SC1 for the user to apply for expense reimbursement is illustrated. The work screen SC1 includes parts of a user interface. For example, the parts of the user interface may be input forms, buttons, check boxes, icons, or other parts.

In the at least one embodiment, operations relating to the work of the user are defined on the work screen SC1. The operation relating to the work of the user is an operation to be performed by the user to carry out the work. For example, the operation relating to the work of the user may be an operation for inputting a mandatory input item among a plurality of input items on the work screen SC1, or may be an input method for an input item on the work screen SC1. The input item is an item indicated by each of the parts of the user interface. The input item can also be said to be specific content indicated by input performed by the user. The input method is a type of the input. For example, the input method may be a character string, a numerical value, a full-width character, or a half-width character.

For example, on the work screen SC1, a procedure for a plurality of operations in application work for expense reimbursement or the like may be defined, or a procedure for a plurality of operations for approval of workflow may be defined. When the user does not perform operations from the work screen SC1 in accordance with a predetermined procedure, the application work may result in an error. When the user does not perform operations from the work screen SC1 in accordance with a predetermined procedure, the application work may not particularly result in an error, and a person in charge of the application work may instruct the user to correct the application work.

In the case of the example of FIG. 2, the work screen SC1 includes a plurality of input items such as “Application Name” and “Purpose.” The plurality of input items include some mandatory input items and some optional input items. The plurality of input items also include, in terms of the input method, some input items for which input of a character string is required and some input items for which input of a numerical value is required. A user who is not accustomed to the work may not know what operation to perform on the work screen SC1. This point applies similarly to the work screen SC1 for supporting other work other than the expense reimbursement application.

In view of this, the operation support system 1 provides the operation support service to the user. The operation support service is a service that supports operations on the work screen SC1. In the at least one embodiment, the operation support service may support operations of a user in each of work support services of a plurality of third parties. In this case, a plurality of third-party systems 2 may be present. The operation support service may cooperate with the work support service, or may support the operation of the user by receiving information required for supporting the operation from the user terminal 40 without cooperating with the work support service.

The operation support service and the work support service may be provided by the same party. In this case, the operation support server 10 may provide the work support service to the user in the absence of the third-party system 2. The operation support system 1 may include the operation support server 10 and a server computer for the work support service. The server computer may have the same functions as those of the third-party server 20. The operation support service may be a service within the work support service. For example, the operation support service may be a service added as a plug-in of the work support service. Such an aspect is also within the scope of the present disclosure.

In the at least one embodiment, a case in which the operation support service is provided to the user by an extension of the browser is taken as an example, but the operation support service may be provided to the user by another method other than the extension of the browser. For example, the operation support service may be provided to the user by a script included in HTML data of the work screen SC1, a script transmitted to the user terminal 40 separately from the HTML data of the work screen SC1, or another program (for example, a program specific to the operation support service or a program specific to the work support service) other than the script.

The extension of the browser is a program for the user to add a specific function to the browser. The extension can also be said to be a plug-in of the browser. The extension may include data to be referred to by the program. A mechanism of the extension may be the same as a mechanism adopted in a publicly-known browser. The user can select any extension from the browser and add the selected extension thereto. When the user selects the extension and adds the extension to the browser, the extension is installed in the user terminal 40. The extension is called from the browser at any timing.

For example, when the user performs an operation for adding the extension from the browser, the user terminal 40 downloads the extension provided by the operation support service from the operation support server 10 or another computer, and installs the downloaded extension. When the installation of the extension is completed, the user terminal 40 displays an icon I indicating the extension in a window W of the browser. The user can call the extension by selecting the icon I. The user may call the extension from a menu of the browser instead of the icon I.

For example, when the extension is called, as in the upper half of FIG. 3, the user terminal 40 displays, on the work screen SC1, a popup P10 indicating that operation support information for supporting the operation of the user is being acquired. Details of the operation support information are described later. The user terminal 40 transmits the HTML data of the work screen SC1 to the operation support server 10. When the operation support server 10 receives the HTML data of the work screen SC1 from the user terminal 40, the operation support server 10 causes the AI to analyze the HTML data of the work screen SC1 to acquire the operation support information for supporting the operation of the user. Details of the AI are also described later.

In the at least one embodiment, the AI system 3 provides an AI service using the AI to the operation support service or the user. The AI system 3 manages the AI. The operation support server 10 acquires the operation support information corresponding to the HTML data of the work screen SC1 by cooperating with the AI system 3. The operation support server 10 transmits HTML data of a provision screen SC2 for providing the operation support information to the user terminal 40. When the user terminal 40 receives the HTML data of the provision screen SC2, the user terminal 40 displays the provision screen SC2 including the operation support information on the display unit 45 as in the lower half of FIG. 3. In the example in the lower half of FIG. 3, the provision screen SC2 includes, as the operation support information, mandatory input items for the expense reimbursement application and input methods required for the user. The user performs an operation on the work screen SC1 with reference to the operation support information.

As described above, the operation support system 1 according to the at least one embodiment acquires the HTML data of the work screen SC1 from the user terminal 40 based on the extension of the browser. The operation support system 1 acquires the operation support information by causing the AI to analyze the HTML data of the work screen SC1. The operation support system 1 displays, on the user terminal 40, the provision screen SC2 including the operation support information corresponding to the HTML data of the work screen SC1. The user can perform an operation on the work screen SC1 with reference to the operation support information. Details of the operation support system 1 are described below.

### 3. Functions implemented in Operation Support System

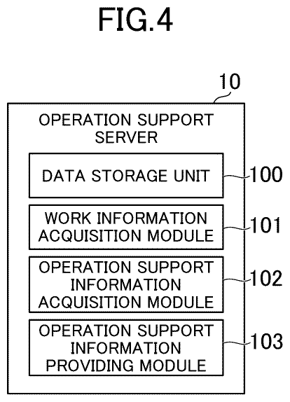

FIG. 4 is a diagram for illustrating an example of functions implemented in the operation support system 1. In FIG. 4, functions implemented in the operation support server 10 are illustrated. For example, the operation support server 10 includes a data storage unit 100, a work information acquisition module 101, an operation support information acquisition module 102, and an operation support information providing module 103. The data storage unit 100 is implemented by the storage unit 12. The work information acquisition module 101, the operation support information acquisition module 102, and the operation support information providing module 103 are implemented by the control unit 11.

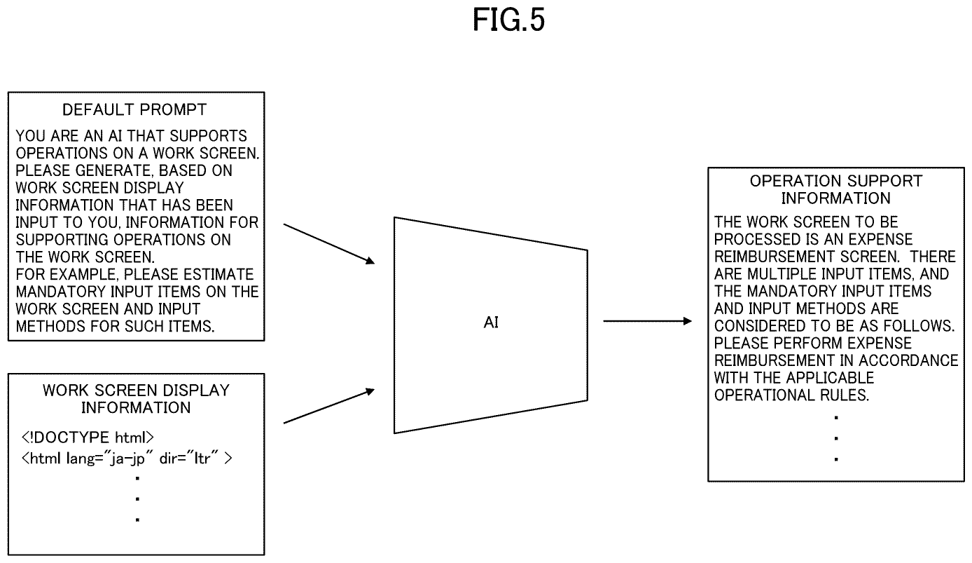

FIG. 5 is a diagram for illustrating an example of AI inputs and an AI output. In the at least one embodiment, a case in which the AI is managed by the AI system 3 is taken as an example, and hence the input to the AI can also be said to be information transmitted by the operation support server 10 to the AI system 3. The information input to the AI is hereinafter referred to as “input information.” The output from the AI can also be said to be information received by the operation support server 10 from the AI system 3. In the at least one embodiment, the operation support information is output from the AI. Now, an example of a function of each of the data storage unit 100, the work information acquisition module 101, the operation support information acquisition module 102, and the operation support information providing module 103 is described with reference to FIG. 5.

### [Data Storage Unit]

The data storage unit 100 stores data required for the operation support service. For example, the data storage unit 100 stores a default prompt, which is a prompt prepared in advance by default. The prompt is an instruction to the AI. In the at least one embodiment, a case in which text written in a natural language corresponds to the prompt is taken as an example, but the prompt may also be text written in another language (for example, a programming language or a database language) other than the natural language. The prompt may also be in another format (for example, a document format, an image format, or a table format) other than the text.

For example, the default prompt indicates content of processing to be executed by the AI. In the at least one embodiment, a case in which a general-purpose AI that is not specialized for a specific task is used is taken as an example. Thus, the default prompt indicates a task of the AI. The task is content of processing to be executed by the AI. The default prompt may indicate a type of product to be generated by the AI. The default prompt may indicate what is to be input as the input information. The default prompt may indicate a role of the AI. In the at least one embodiment, a case in which the default prompt is prepared by an administrator of the operation support service is taken as an example, but the default prompt may be prepared by the user.

In the example of FIG. 5, the default prompt indicates text such as “You are an AI that supports operations on a work screen. Please generate, based on work screen display information that has been input to you, information for supporting operations on the work screen. For example, please estimate mandatory input items on the work screen and input methods for such items.” In this default prompt, the portion “You are an AI that supports operations on a work screen.” indicates the role of the AI. The next portion “Please generate, based on work screen display information that has been input to you, information for supporting operations on the work screen.” indicates specific content of the input information and specific content of the product to be generated by the AI. The last portion “For example, please estimate mandatory input items on the work screen and input methods for such items.” indicates an example of the product to be generated by the AI.

The work screen display information is a type of input information. Details of the work screen display information are described later. The default prompt may be any wording. The default prompt is not limited to the wording of FIG. 5. The default prompt may include any wording that means that the AI is to generate operation support information based on work information. The default prompt may be any one of various wordings that may be adopted by a person skilled in the art in the field of AI as a prompt required for operation support based on the work information in the state of the art at the time of filing.

In the at least one embodiment, a case in which the AI system 3 manages the AI is taken as an example, but the operation support system 1 may manage the AI. When the operation support system 1 manages the AI, the data storage unit 100 stores actual data of the AI. The AI is a program capable of generating an electronic product based on input information that is information input to the AI. The AI may also be called a generative AI. There are various views in terms of definitions of the AI, but the AI in the at least one embodiment may be an AI in any one of various publicly-known definitions. For example, the generative AI may not only be an AI developed by a machine learning method but also an AI developed by another method other than the machine learning.

For example, the AI may be a large language model, a machine learning model not classified as a large language model (a model trained by using a machine learning method, for example, a model such as generative adversarial networks (GAN) or variational autoencoders (VAE)), or another model. In the at least one embodiment, a case in which a pre-trained large language model corresponds to the AI is taken as an example. The large language model may be of any type. For example, the large language model may be a transformer-based model such as a generative pre-trained transformer (GPT) or bidirectional encoder representations from transformers (BERT), or another model not classified as a transformer (for example, a neural network).

For example, the AI includes a program that indicates a series of processes for generating a product based on the input information, and parameters to be referred to by the program. The parameters may be incorporated into a part of an AI program. The parameters of the AI may be similar to publicly-known parameters. For example, the parameters of the AI may be weights and biases. The AI may include other information other than the program and the parameters. The AI may be a single-modal type AI that can process only the input information in a specific format, or may be a multi-modal type AI that can process the input information in a plurality of formats.

For example, the AI may include an input layer that processes the input information, an intermediate layer that calculates an embedded representation of the input information based on the parameters, and an output layer that outputs a product corresponding to the embedded representation. The embedded representation is information for the AI to recognize the input information. The embedded representation may also be called a feature amount or a feature vector. The embedded representation may be a multidimensional vector, or may be in another form (for example, an array, a matrix, a single numerical value, or a plurality of numerical values). The input information may be divided into units called tokens. The AI may calculate embedded representations for individual tokens.

In the at least one embodiment, the AI is assumed to have already learned various kinds of training data for training. When a model capable of natural language processing, which is exemplified by the large language model, corresponds to the AI, the AI is assumed to have already learned various kinds of text for training as the training data. The parameters of the AI have been adjusted by learning the training data. A general-purpose AI that has been subjected to pre-training may be used as it is, or an AI that has been fine-tuned for the operation support system 1 may be used. The learning method for the AI may be similar to a publicly-known machine learning method. As with the definitions of the AI, there are various views in terms of definitions of the machine learning, but the machine learning in the at least one embodiment includes various publicly-known definitions. For example, deep learning is also included in the machine learning.

The data stored in the data storage unit 100 is not limited to the above-mentioned examples. The data storage unit 100 may store data required for providing the operation support service. For example, the data storage unit 100 may store a user database in which information on each of a plurality of users using the operation support service is stored. The data storage unit 100 may store actual data of the extension provided by the operation support service. For example, the extension may include program code indicating processing in which the user terminal 40 transmits the work screen display information to the operation support server 10, and program code indicating processing in which the user terminal 40 acquires the operation support information from the operation support server 10 and displays the acquired operation support information. The user terminal 40 executes the processing described in the at least one embodiment by executing the above-mentioned program code. The data storage unit 100 may store display data (for example, HTML data) required for displaying the provision screen SC2.

### [Work Information Acquisition Module]

The work information acquisition module 101 acquires work information relating to the work screen SC1 on which operations relating to the work of the user are defined, the work screen SC1 being displayed on the user terminal 40 of the user. The work information is information on the work screen SC1 itself, information on work performed on the work screen SC1, information on the user who has displayed the work screen SC1, information on an organization to which the user who has displayed the work screen SC1 belongs, or information on another user belonging to the same organization as the organization to which the user who has displayed the work screen SC1 belongs. The work information acquisition module 101 acquires the work information from the data storage unit 100, the user terminal 40, another computer other than the user terminal 40, or an external information storage medium. The work information may be in any data format. For example, the work information may be in a document format, an image format, a table format, a markup language format such as HTML, or another format.

In the at least one embodiment, the work information acquisition module 101 acquires, as the work information, the work screen display information for displaying the work screen SC1 on the user terminal 40. Thus, the work screen display information is described as an example of the work information. Other examples of the work information are described in modification examples described later. The work information is a concept that encompasses the work screen display information and other examples described in the modification examples described later. The work screen display information is information on the work screen SC1 itself. For example, the work screen display information is all or a part of display data (for example, HTML data) for displaying the work screen SC1, or all or a part of a document object model (DOM) for manipulating the data.

In the at least one embodiment, a case in which the HTML data of the work screen SC1 corresponds to the work screen display information is taken as an example. Thus, the HTML data of the work screen SC1 as used herein can be replaced as the work screen display information. The HTML data of the work screen SC1 includes text of labels of input items, other text displayed on the work screen SC1, tags capable of identifying parts serving as the user interface, positions of respective elements on the work screen SC1, scripts of the work screen SC1, or other information.

For example, the user terminal 40 transmits the HTML data of the work screen SC1 to the operation support server 10. The work information acquisition module 101 acquires the HTML data of the work screen SC1 from the user terminal 40. The user terminal 40 may transmit the HTML data of the work screen SC1 to another computer (for example, the third-party server 20) other than the operation support server 10. In this case, the work information acquisition module 101 may acquire the HTML data of the work screen SC1 through the another computer.

The work screen display information may be not all of the HTML data of the work screen SC1, and may be only a part of the HTML data of the work screen SC1. For example, the work screen display information may be only a portion relating to parts of the user interface in the HTML data of the work screen SC1. The portion relating to the parts of the user interface is at least one of code (a tag) indicating a part such as an input form or text of a label written before or after the code (the tag). The work screen display information may be only a portion of the HTML data of the work screen SC1 in which a script is described.

In the at least one embodiment, the work screen SC1 is provided by the third-party system 2 different from the operation support system 1, and the operation support service is provided to the user by the extension of the browser. Thus, when the work screen SC1 provided by the third-party system 2 different from the operation support system 1 is displayed on the browser of the user terminal 40, the work information acquisition module 101 acquires the work information based on the extension of the browser. For example, the user terminal 40 transmits the work screen display information to the operation support server 10 as the work information by executing the extension of the browser. Processing for this transmission is indicated in the program code included in the extension of the browser. The work information acquisition module 101 acquires, as the work information, the work screen display information transmitted by the extension of the browser from the user terminal 40.

When the extension of the browser is not used, the work information acquisition module 101 acquires the work screen display information without being based on the extension of the browser. For example, the work information acquisition module 101 may acquire the work screen display information based on the script of the work screen SC1. In this case, the script includes program code for transmission of the work screen display information. The user terminal 40 transmits the work screen display information to the operation support server 10 based on the script. The work information acquisition module 101 may acquire the work screen display information transmitted by the script. In addition, for example, the user terminal 40 may transmit the work screen display information to the operation support server 10 based on another program (for example, a program specific to the work support service or a program specific to the operation support service) other than the browser. The work information acquisition module 101 may acquire the work screen display information transmitted by the another program.

### [Operation Support Information Acquisition Module]

The operation support information acquisition module 102 acquires the operation support information relating to support for operations on the work screen SC1 based on the work information and the AI. The operation support information acquisition module 102 inputs the work information to the AI to acquire the operation support information generated by the AI. In the at least one embodiment, a case in which the work screen display information is acquired as the work information is taken as an example, and hence the operation support information acquisition module 102 acquires the operation support information based on the work screen display information and the AI. The operation support information acquisition module 102 inputs the work screen display information to the AI to acquire the operation support information generated by the AI.

In the at least one embodiment, the case in which a general-purpose AI that is not specialized for a specific task is used is taken as an example. Thus, the operation support information acquisition module 102 acquires the operation support information by causing the AI to generate operation support information based on a prompt indicating that the AI is to generate operation support information based on the work information. Further, in the at least one embodiment, the default prompt is described as an example of the prompt, but the prompt may be input by the user. For example, the user may input the prompt from the work screen SC1, or may input the prompt from another screen (for example, an online-chat screen in the modification examples described later) other than the work screen SC1.

The operation support information is information for supporting the operation of the user. The operation support information indicates an estimation result obtained by the AI estimating an appropriate operation on the work screen SC1. In other words, the operation support information indicates specific content of an appropriate operation estimated by the AI. In the at least one embodiment, a case in which the operation support information is in a text format in which the operation support information is written in a natural language is taken as an example, but the operation support information may be in any data format, and is not limited to the text format. For example, the operation support information may be in a document format, an image format, a table format, a markup language format such as HTML, or another format. The operation support information may include information in each of a plurality of formats.

For example, as illustrated in FIG. 5, the operation support information acquisition module 102 inputs the default prompt and the work screen display information to the AI as the input information. The work screen display information may be embedded in the default prompt. In the at least one embodiment, the AI system 3 manages the AI, and hence the operation support information acquisition module 102 inputs the default prompt and the work screen display information to the AI by transmitting those pieces of information to the AI server 30. When the AI server 30 acquires the default prompt and the work screen display information from the operation support server 10, the AI server 30 may input those pieces of information as the input information to the AI stored in the AI server 30. When the actual data of the AI is stored in the data storage unit 100, the operation support information acquisition module 102 may input the default prompt and the work screen display information to the AI stored in the data storage unit 100 without communicating to and from an external computer.

For example, the AI calculates an embedded representation of the default prompt and the work screen display information that have been input to the AI based on parameters adjusted by pre-training. The AI may divide the default prompt and the work screen display information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt and the work screen display information are divided into tokens, the AI generates and outputs operation support information corresponding to a sequence of the embedded representations of the individual tokens. Internal processing of the AI is not limited to the example of the at least one embodiment. The internal processing of the AI may be processing similar to that of a publicly-known AI.

In the example of FIG. 5, the AI estimates appropriate content as the input items and input methods specified by the default prompt, and outputs the estimated content as the operation support information. When information of parts of the user interface is indicated in the work screen display information, the AI estimates the input items and the input methods from the information of the parts of the user interface, and outputs the operation support information indicating the estimation result. This series of processing steps is implemented by the calculation of the embedded representation described above. The operation support information acquisition module 102 acquires the operation support information output from the AI. In the at least one embodiment, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

The AI is not required to be a general-purpose AI specialized for a specific task, and may be an AI specialized for the task of generating the operation support information. In this case, training data indicating a relationship between work screen display information for training and operation support information for training is assumed to have been learned by the AI. The learning of the training data may be executed by the operation support server 10, or may be executed by another computer. The AI is trained so that, when the work screen display information for training, which is indicated by the training data, is input to the AI, the operation support information for training, which is indicated by the training data, is output from the AI.

Further, the AI may be trained by a publicly-known learning method used in a machine learning method. For example, the training data may be learned by the AI by an error backpropagation method or a gradient descent method. When the AI is specialized for a specific task, the AI can generate the operation support information even without particularly having a prompt input thereto, and hence the operation support information acquisition module 102 may input the operation support information to the AI without inputting a prompt to the AI. In this way, a mode in which the operation support information is generated without the input of a prompt is also within the scope of the present disclosure.

### [Operation Support Information Providing Module]

The operation support information providing module 103 provides the operation support information to the user. Providing the operation support information to the user by the operation support information providing module 103 means that the operation support information providing module 103 transmits the operation support information to the user terminal 40. The operation support information providing module 103 may transmit the operation support information directly to the user terminal 40, or may transmit the operation support information indirectly through another computer (for example, the third-party server 20). For example, the operation support information providing module 103 provides the operation support information to the user by transmitting the operation support information to the third-party system 2 or the user terminal 40.

For example, the operation support information providing module 103 may provide only the operation support information to the user, or may provide overall information including the operation support information and other information. In the at least one embodiment, the operation support information providing module 103 provides the operation support information to the user by transmitting display data of the provision screen SC2 including the operation support information to the user terminal 40. The display data is data for displaying a screen on the user terminal 40. The display data may be in any data format, and may be, for example, data in a markup language such as HTML or XML. In the example of FIG. 3, the provision screen SC2 is a web page of a domain (for example, “zzzservice.co.jp”) of the operation support service. The provision screen SC2 may be a web page of a domain (for example, “aaa.com”) of the work support service.

The operation support information providing module 103 may provide the operation support information to the user on another screen other than the provision screen SC2. For example, the operation support information providing module 103 may provide the operation support information on the work screen SC1. The operation support information providing module 103 may provide the operation support information to the user through use of a popup different from the work screen SC1 and the provision screen SC2. The operation support information providing module 103 may provide the operation support information to the user through use of a side panel of the browser. The operation support information providing module 103 may provide the operation support information to the user through use of notification means such as email.

### 4. Processing executed in Operation Support System

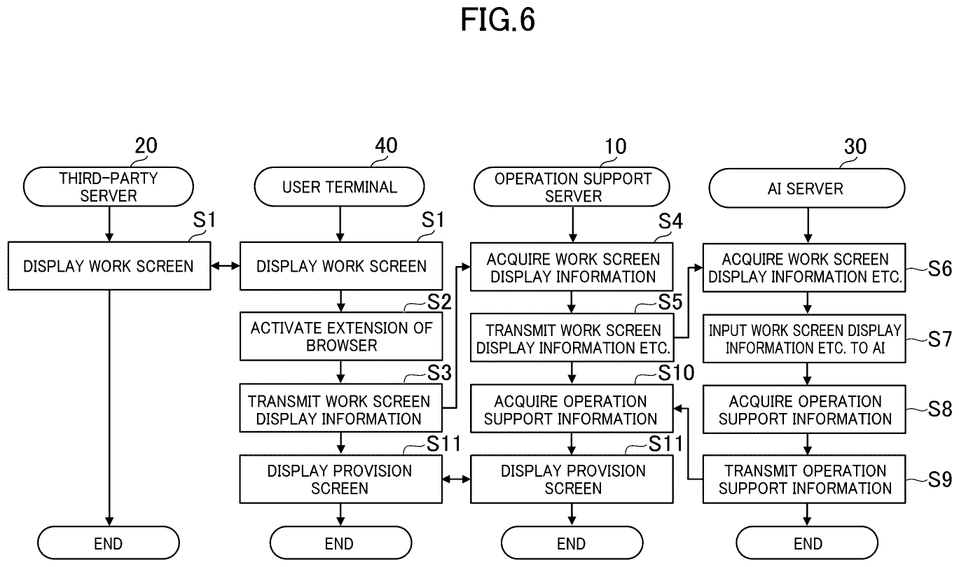

FIG. 6 is a flowchart for illustrating an example of processing executed in the operation support system 1. The processing of FIG. 6 is executed by the control units 11, 21, 31, and 41 executing the programs stored in the storage units 12, 22, 32, 42, respectively. The processing of FIG. 6 is an example of processing included in the operation support method. When the processing of FIG. 6 is executed, it is assumed that the user has added the extension provided by the operation support service to the browser.

As illustrated in FIG. 6, when the user logs in to the work support service, the user terminal 40 executes, between the user terminal 40 and the third-party server 20, processing for displaying the work screen SC1 (Step S1). In Step S1, the third-party server 20 transmits the HTML data of the work screen SC1 to the user terminal 40. The user terminal 40 records the HTML data of the work screen SC1 in the storage unit 42, and displays the work screen SC1 on the display unit 45. When the user completes the expense reimbursement application from the work screen SC1 without particularly selecting the icon I, Step S2 and the subsequent processing steps are not executed, and the processing ends.

When the user selects the icon I, the user terminal 40 activates the extension of the browser (Step S2). The user terminal 40 transmits, based on the extension of the browser, the HTML data of the work screen SC1 stored in the storage unit 42 to the operation support server 10 as the work screen display information (Step S3). The operation support server 10 acquires the HTML data of the work screen SC1 from the user terminal 40 as the work screen display information (Step S4). The operation support server 10 inputs the default prompt stored in the storage unit 42 and the work screen display information acquired from the user terminal 40 to the AI by transmitting those pieces of information to the AI server 30 (Step S5).

The AI server 30 acquires the default prompt and the work screen display information from the operation support server 10 (Step S6). The AI server 30 inputs the default prompt and the work screen display information to the AI as the input information (Step S7). In Step S7, the AI calculates an embedded representation of the default prompt and the work screen display information that have been input to the AI, and outputs the operation support information corresponding to the embedded representation. The AI server 30 acquires the operation support information output from the AI (Step S8). The AI server 30 transmits the operation support information to the operation support server 10 (Step S9). The operation support server 10 acquires the operation support information from the AI server 30 (Step S10).

The operation support server 10 executes, between the operation support server 10 and the user terminal 40, processing for displaying the provision screen SC2 including the operation support information (Step S11), and the processing ends. In Step S11, the operation support server 10 acquires the HTML data of the provision screen SC2 including the operation support information. It is assumed that HTML data indicating a format of the provision screen SC2 (for example, another portion of the provision screen SC2 other than the operation support information) is stored in the storage unit 12 in advance. The operation support server 10 acquires the provision screen SC2 by inserting the operation support information into the HTML data indicating the format. The user performs an operation on the work screen SC1 with reference to the operation support information in the provision screen SC2.

### 5. Summary of at Least One Embodiment

The operation support system 1 according to the at least one embodiment acquires the work information. The operation support system 1 acquires the operation support information based on the work information and the AI. The operation support system 1 provides the operation support information to the user. As a result, the user can perform an operation on the work screen SC1 with reference to the operation support information, and hence the operation support system 1 can reduce the time and effort of the user. For example, when the user does not understand the operation on the work screen SC1, the user can know the operation to be performed by the user by viewing the operation support information without searching a help page or the like by himself or herself. In the case of the example of FIG. 2 and FIG. 3, the user can easily know mandatory input items among the input items on the work screen SC1, and input methods for the input items, on the provision screen SC2.

Further, when the work screen SC1 provided by the third-party system 2 is displayed on the browser of the user terminal 40, the operation support system 1 acquires the work information based on the extension of the browser. The operation support system 1 provides the operation support information to the user by transmitting the operation support information to the third-party system 2 or the user terminal 40. As a result, the user can use the operation support information through use of simple means, namely, the extension of the browser, and hence the operation support system 1 can further reduce the time and effort of the user. When the operation support system 1 transmits the operation support information to the third-party system 2, the operation support system 1 can provide the operation support information to the user through the third-party system 2 even without an environment for directly transmitting the operation support information to the user terminal 40. When there is an environment in which the operation support system 1 transmits the operation support information to the user terminal 40, the operation support system 1 can provide the operation support information to the user even without intermediation of the third-party system 2. In the case of the example of FIG. 2 and FIG. 3, the user can use the operation support information by a simple operation for selecting the icon I indicating the extension provided by the operation support service.

Further, the operation support system 1 acquires, as the work information, the work screen display information for displaying the work screen SC1 on the user terminal 40. The operation support system 1 acquires the operation support information based on the work screen display information and the AI. The operation support system 1 can improve accuracy of the operation support information by acquiring the operation support information based on the work screen display information in which the configuration of the work screen SC1 is indicated. For example, when the operation support system 1 acquires the HTML data of the work screen SC1 as the work screen display information, the operation support system 1 can further improve the accuracy of the operation support information by acquiring the operation support information based on the HTML data in which a more detailed configuration of the work screen SC1 is indicated.

### 6. Modification Examples

The present disclosure is not limited to the at least one embodiment described above. The present disclosure can be modified as required without departing from the purport of the present disclosure.

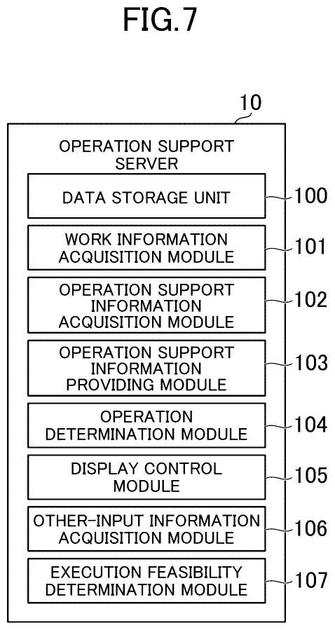

FIG. 7 is a diagram for illustrating an example of functions implemented in the operation support system 1 according to the modification examples. As illustrated in FIG. 7, in the operation support system 1 according to the modification example, an operation determination module 104, a display control module 105, an other-input information acquisition module 106, and an execution feasibility determination module 107 are implemented. For example, each of the operation determination module 104, the display control module 105, the other-input information acquisition module 106, and the execution feasibility determination module 107 is implemented by the control unit 11.

### [6-1. Modification Example 1]

For example, in the at least one embodiment, the work screen display information has been described as an example of the work information. The work information may be any information relating to the work screen SC1. The work information is not limited to the work screen display information. Other examples of the work information are described below in Modification Examples 1 to 5 and 7. The work information is information representing a higher-level concept that encompasses the above-mentioned plurality of examples. The work information may include a plurality of pieces of information among the work screen display information described in the at least one embodiment and other examples described in Modification Examples 1 to 5 and 7.

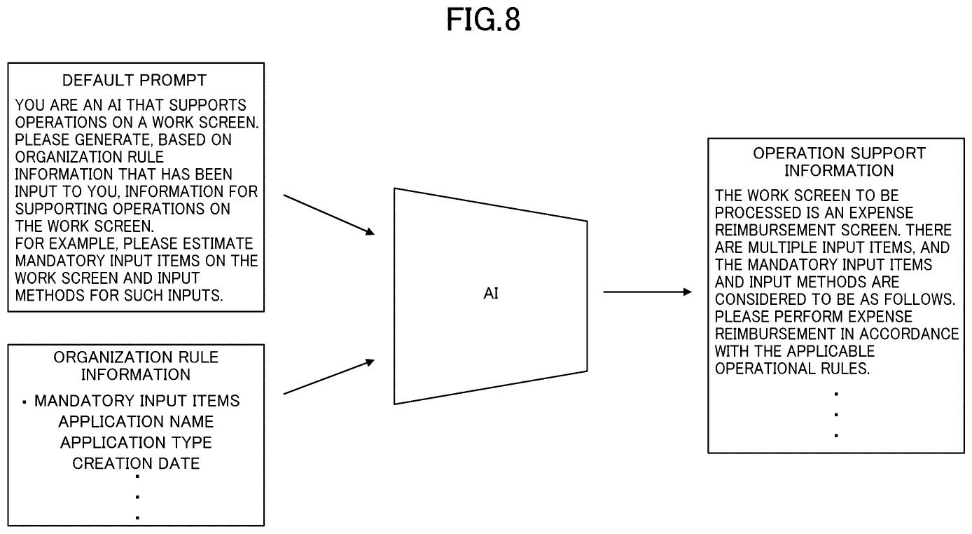

FIG. 8 is a diagram for illustrating an example of AI inputs and an AI output in Modification Example 1. As illustrated in FIG. 8, the work information acquisition module 101 acquires, as the work information, organization rule information relating to rules relating to work on the work screen SC1, the rules being defined in an organization to which the user belongs. The rule is a rule of operation on the work screen SC1. The rule defines in which input item on the work screen SC1 and by what kind of input method the user is to input information. The rule can also be said to be a policy.

In the example of the work screen SC1 of FIG. 2, the organization rule information indicates mandatory input items on the work screen SC1 and input methods for the input items. The organization rule information may indicate only one of the mandatory input items or the input methods for the input items. The organization rule information may indicate other content. The content indicated by the organization rule information is not limited to the mandatory input items and the input methods for the input items. For example, the organization rule information may indicate a procedure for a series of operations performed on the work screen SC1, specific content of information to be input in an input item by the user, a deadline by which the user is to perform an operation on the work screen SC1, or other content.

In Modification Example 1, it is assumed that the organization rule information is stored in the third-party server 20. For example, the third-party server 20 stores an organization database in which organization identification information capable of identifying an organization that has contracted with the work support service and the organization rule information on the organization are associated with each other. The organization identification information may be an ID assigned to the organization or a name of the organization. The organization rule information may indicate any rule relating to work. For example, the organization rule information may indicate mandatory input items on the work screen SC1, input methods for the input items on the work screen SC1, content prohibited from being input on the work screen SC1, content encouraged to be input on the work screen SC1, or a combination thereof.

For example, an administrator of a certain organization operates his or her user terminal 40 to access the third-party server 20, and registers, in the organization database, the organization rule information indicating rules in his or her organization. Specific content of the organization rule information is input by the administrator. The organization rule information may be in any data format processable by the AI. When a large language model is used as the AI, the organization rule information indicates text written in a natural language. When the AI supports other data formats such as an image format, the organization rule information may be in another data format. When the AI supports multi-modal data, the organization rule information may be information in which rules of the organization are shown in a plurality of data formats such as a text format and an image format.

In the example of FIG. 8, the organization rule information indicates mandatory input items on the work screen SC1 and input methods for the input items. For example, the administrator of the organization creates the organization rule information by inputting labels of mandatory input items on the work screen SC1 and input methods for the input items in natural language text. The natural language text is not required to be sentences, and may be a list of input items and input methods as illustrated in FIG. 8. When a plurality of work screens SC1 are used in work of a certain organization, separate organization rule information may be defined for each of the work screens SC1. In this case, it is assumed that information capable of identifying the work screen SC1 and the organization rule information corresponding to the work screen SC1 are associated with each other in the organization database. The work information acquisition module 101 may acquire the organization rule information corresponding to the work screen SC1 being displayed on the user terminal 40.

For example, when the work screen SC1 is displayed on the user terminal 40 of a user belonging to a certain organization, the work information acquisition module 101 acquires the organization rule information associated with the organization identification information on the organization. In a case in which the extension of the browser is used in the same manner as in the at least one embodiment, when the user selects the icon I and the extension of the browser is activated, the user terminal 40 acquires, from the organization database, the organization rule information on the organization to which the user belongs. The organization to which the user belongs may be indicated in the organization database, or may be indicated in another database (for example, a user database in which various kinds of information relating to users are stored) different from the organization database. The third-party server 20 may identify, based on those databases, the organization to which the user belongs. When the user terminal 40 acquires the organization rule information from the third-party server 20, the user terminal 40 transmits the organization rule information to the operation support server 10. The work information acquisition module 101 acquires the organization rule information from the user terminal 40.

The organization rule information may be included in the HTML data of the work screen SC1. In this case, when the extension of the browser is activated, the user terminal 40 may transmit the organization rule information included in the HTML data of the work screen SC1 to the operation support server 10. The work information acquisition module 101 may acquire the organization rule information from the third-party server 20 instead of acquiring the organization rule information from the user terminal 40. For example, the work information acquisition module 101 may acquire, from the user terminal 40, the organization identification information on the organization to which the user belongs, and request the third-party server 20 to acquire the organization rule information associated with the organization identification information. The third-party server 20 transmits, based on this request, the organization rule information on the organization to which the user belongs to the operation support server 10.

Further, the data storage unit 100 may store the organization database. In this case, the work information acquisition module 101 may acquire the organization rule information from the organization database stored in the data storage unit 100. The organization database may be stored in another computer other than the operation support server 10 and the third-party server 20, or may be stored in an information storage medium. The work information acquisition module 101 may acquire the organization rule information from the operation support server 10, the third-party server 20, another computer, or the information storage medium.

The operation support information acquisition module 102 in Modification Example 1 acquires the operation support information based on the organization rule information and the AI. For example, as illustrated in FIG. 8, the operation support information acquisition module 102 inputs the default prompt and the organization rule information to the AI as the input information. The organization rule information may be embedded in the default prompt. The default prompt in Modification Example 1 includes a wording that instructs to generate operation support information based on the organization rule information. This wording may be any wording that means that the operation support information is to be generated based on the organization rule information, and is not limited to the example of FIG. 8.

For example, the operation support information acquisition module 102 inputs the default prompt and the organization rule information to the AI by transmitting those pieces of information to the AI server 30. When the AI server 30 acquires the default prompt and the organization rule information from the operation support server 10, the AI server 30 inputs those pieces of information as the input information to the AI stored in the AI server 30. When the actual data of the AI is stored in the data storage unit 100, the operation support information acquisition module 102 may input the default prompt and the organization rule information to the AI stored in the data storage unit 100 without communicating to and from an external computer.

For example, the AI calculates an embedded representation of the default prompt and the organization rule information that have been input to the AI based on parameters adjusted by pre-training. The AI may divide the default prompt and the organization rule information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt and the organization rule information are divided into tokens, the AI generates and outputs operation support information corresponding to a sequence of the embedded representations of the individual tokens.

In the example of FIG. 8, the AI estimates appropriate content as the input items and input methods specified by the default prompt, and outputs the estimated content as the operation t information. When the organization rule information indicates mandatory input items and input methods for the input items, the AI outputs the operation support information indicating the input items and input methods indicated in the organization rule information. The operation support information acquisition module 102 acquires the operation support information output from the AI. In Modification Example 1, the AI system 3 manages the AI, and hence the AI server 30 transmits the operation support information to the operation support server 10. The operation support information acquisition module 102 acquires the operation o support information from the AI server 30. When the actual data of the AI is stored in the data storage unit 100, the operation support information acquisition module 102 may acquire the operation support information without communicating to and from an external computer.

In Modification Example 1 as well, in the same manner as in the at least one embodiment, when the AI is specialized for the task of generating operation support information, the default prompt is not required to be input to the AI. When the user inputs the prompt by himself or herself, the default prompt is not required to be input to the AI. In Modification Example 1, the processing steps after the operation support information is acquired may be the same as those of the at least one embodiment. That is, the processing of the operation support information providing module 103 in Modification Example 1 may be the same as that of the at least one embodiment.

The operation support system 1 according to Modification Example 1 acquires the organization rule information as the work information. The operation support system 1 acquires the operation support information based on the organization rule information and the AI. As a result, the operation support system 1 can provide the operation support information corresponding to rules in the organization to which the user belongs to the user, and hence flexible operation support corresponding to the organization can be performed. For example, even when a rule specific to the organization is defined, the AI can recognize the rule based on the organization rule information and output the operation support information, and hence the user can know an operation corresponding to the rule specific to the organization.

### [6-2. Modification Example 2]

For example, when a user belonging to a certain organization is troubled with an operation on the work screen SC1, an operation performed on the same work screen SC1 by another user belonging to the same organization may be helpful. In view of this, in Modification Example 2, other-user operation information relating to an operation performed on the same screen as the work screen SC1 by another user belonging to the same organization as the organization to which the user belongs is described as an example of the work information. The other-user operation information indicates specific content of an operation performed by another user on the work screen SC1. For example, the other-user operation information may indicate at least one of an input item input on the work screen SC1 by another user or an input method for the input item. The other-user operation information may indicate specific content actually input by another user. The other-user operation information may indicate an operation performed by each of a plurality of other users.

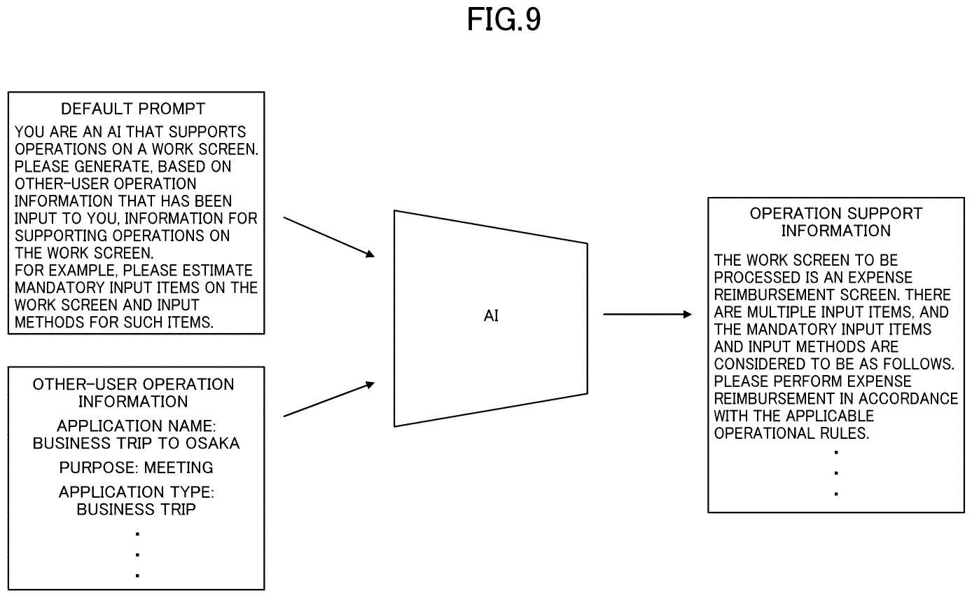

FIG. 9 is a diagram for illustrating an example of AI inputs and an AI output in Modification Example 2. As illustrated in FIG. 9, the work information acquisition module 101 acquires the other-user operation information as the work information. In Modification Example 2, it is assumed that the other-user operation information is stored in the third-party server 20. For example, the third-party server 20 stores an organization database in which the organization identification information capable of identifying an organization that has contracted with the work support service and the other-user operation information on the organization are associated with each other. The other-user operation information may be stored in another database other than the organization database.

For example, when another user performs an operation on the work screen SC1, the user terminal 40 of the another user transmits the other-user operation information indicating content of the operation of the another user to the third-party server 20. The third-party server 20 registers the other-user operation information in the organization database in association with the organization identification information on the organization to which the another user belongs. The other-user operation information may be in any data format processable by the AI. When a large language model is used as the AI, the other-user operation information indicates text written in a natural language. When the AI supports other data formats such as an image format, the other-user operation information may be in another data format. When the AI supports multi-modal data, the other-user operation information may be information in which an operation of another user is shown in a plurality of data formats such as a text format and an image format.

In the example of FIG. 9, the other-user operation information indicates specific content that has been input by another user on the work screen SC1 in natural language text. The natural language text is not required to be a sentence, and may be content that has been input into an input form on the work screen SC1 as illustrated in FIG. 9. When a plurality of work screens SC1 are used in work of a certain organization, separate other-user operation information may be stored in the organization database for each work screen SC1. In this case, it is assumed that information capable of identifying the work screen SC1 and the other-user operation information corresponding to the work screen SC1 are associated with each other in the organization database. The work information acquisition module 101 may acquire the other-user operation information corresponding to the work screen SC1 being displayed on the user terminal 40.

For example, when the work screen SC1 is displayed on the user terminal 40 of a user belonging to a certain organization, the work information acquisition module 101 acquires the other-user operation information associated with the organization identification information on the organization. In a case in which the extension of the browser is used in the same manner as in the at least one embodiment, when the user selects the icon I and the extension of the browser is activated, the user terminal 40 acquires the other-user operation information on the organization to which the user belongs from the organization database. The user terminal 40 transmits the other-user operation information to the operation support server 10. The work information acquisition module 101 acquires the other-user operation information from the user terminal 40. When a plurality of pieces of other-user operation information are associated with the organization identification information on a certain organization, the work information acquisition module 101 may acquire all the plurality of pieces of other-user operation information, or may acquire only a part thereof.

The other-user operation information may be included in the HTML data of the work screen SC1. In this case, when the extension of the browser is activated, the user terminal 40 may transmit the other-user operation information included in the HTML data of the work screen SC1 to the operation support server 10. The work information acquisition module 101 may acquire the other-user operation information from the third-party server 20 instead of acquiring the other-user operation information from the user terminal 40. For example, the work information acquisition module 101 may acquire the organization identification information on the organization to which the user belongs from the user terminal 40, and request the third-party server 20 to acquire the other-user operation information associated with the organization identification information. The third-party server 20 transmits, based on this request, the other-user operation information on another user belonging to the same organization as the organization to which the user belongs to the operation support server 10.

Further, in the same manner as in Modification Example 1, the data storage unit 100 may store the organization database. In this case, the work information acquisition module 101 may acquire the other-user operation information from the organization database stored in the data storage unit 100. In the same manner as in Modification Example 1, the other-user operation information may be stored in any location. The work information acquisition module 101 may acquire the other-user operation information from the operation support server 10, the third-party server 20, another computer, or the information storage medium.

The operation support information acquisition module 102 in Modification Example 2 acquires the operation support information based on the other-user operation information and the AI. For example, as illustrated in FIG. 9, the operation support information acquisition module 102 inputs the default prompt and the other-user operation information to the AI as the input information. The other-user operation information may be embedded in the default prompt. The default prompt in Modification Example 2 includes a wording that instructs to generate operation support information based on the other-user operation information. This wording may be any wording that means that the operation support information is to be generated based on the other-user operation information, and is not limited to the example of FIG. 9.

For example, the operation support information acquisition module 102 inputs the default prompt and the other-user operation information to the AI by transmitting those pieces of information to the AI server 30. When the AI server 30 acquires the default prompt and the other-user operation information from the operation support server 10, the AI server 30 inputs those pieces of information as the input information to the AI stored in the AI server 30. When the actual data of the AI is stored in the data storage unit 100, the operation support information acquisition module 102 may input the default prompt and the other-user operation information to the AI stored in the data storage unit 100 without communicating to and from an external computer.

For example, the AI calculates an embedded representation of the default prompt and the other-user operation information that have been input to the AI based on parameters adjusted by pre-training. The AI may divide the default prompt and the other-user operation information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt and the other-user operation information are divided into tokens, the AI generates and outputs operation support information corresponding to a sequence of the embedded representations of the individual tokens.

In the example of FIG. 9, the AI estimates appropriate content as the input items and input methods specified by the default prompt, and outputs the estimated content as the operation support information. When the other-user operation information indicates mandatory input items and input methods for the input items, the AI outputs the operation support information indicating the input items and input methods indicated in the other-user operation information. The operation support information acquisition module 102 acquires the operation support information output from the AI. In Modification Example 2, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

In Modification Example 2 as well, in the same manner as in the at least one embodiment, when the AI is specialized for the task of generating operation support information, the default prompt is not required to be input to the AI. When the user inputs the prompt by himself or herself, the default prompt is not required to be input to the AI. In Modification Example 2, the processing steps after the operation support information is acquired may be the same as those of the at least one embodiment. That is, the processing of the operation support information providing module 103 in Modification Example 2 may be the same as that of the at least one embodiment.

The operation support system 1 according to Modification Example 2 acquires the other-user operation information as the work information. The operation support system 1 acquires the operation support information based on the other-user operation information and the AI. As a result, the operation support system 1 can provide the user with the operation support information corresponding to operations actually performed by other users belonging to the same organization as that of the user, and hence flexible operation support corresponding to the organization can be performed. For example, the user can perform an operation on the work screen SC1 with reference to the operation support information generated by the AI in accordance with an operation actually performed by a colleague or a senior. The operation support system 1 does not provide the user with the other-user operation information corresponding to operations actually performed by other users as it is as the operation support information, and hence privacy of other users can also be protected.

### [6-3. Modification Example 3]

For example, the other-user operation information in Modification Example 2 may include content relating to privacy of other users. Thus, access to the other-user operation information by the user may be restricted. In addition, the other-user operation information may be input to the AI under a state in which a portion of input items corresponding to content relating to privacy of O ther users in content indicated by the other-user operation information is masked or deleted.

For example, when the third-party server 20 manages the other-user operation information, the third-party server 20 restricts access to the other-user operation information. An access restriction method itself may be a publicly-known method. The other-user operation information may be associated with identification information on a person having an access right to the other-user operation information. In Modification Example 3, when a user who has the work screen SC1 displayed is not indicated in the identification information, the user cannot directly access the other-user operation information, but it is assumed that input of the other-user operation information to the AI is permitted in order to support the work of the user. The other-user operation information is accessible only to a specific person in the organization. The third-party server 20 controls access to the other-user operation information based on the identification information on the person having the access right. The access right of the other-user operation information may be managed by another computer (for example, the operation support server 10) other than the third-party server 20.

The work information acquisition module 101 in Modification Example 3 acquires the other-user operation information to which access by the user is restricted. For example, the work information acquisition module 101 acquires the other-user operation information not for a purpose of transmitting the other-user operation information to the user terminal 40 but for a purpose of inputting the other-user operation information to the AI. In Modification Example 3, the user terminal 40 cannot access the other-user operation information and cannot acquire the other-user operation information, and hence the work information acquisition module 101 acquires the other-user operation information from the third-party server 20. It is assumed that identification information on an access right is set for the other-user operation information so that access is possible in response to a request received from the work information acquisition module 101. When the organization database is stored in the data storage unit 100, the work information acquisition module 101 may acquire the other-user operation information without communicating to and from another computer such as the third-party server 20. The work information acquisition module 101 may acquire the other-user operation information from an information storage medium.

For example, when the user selects the icon I and the extension of the browser is activated, the user terminal 40 transmits the organization identification information on the organization to which the user belongs to the operation support server 10. The organization identification information may be included in the HTML data of the work screen SC1, or may be stored in the user terminal 40 in advance. The work information acquisition module 101 requests the third-party server 20 for the other-user operation information associated with the organization identification information acquired from the user terminal 40. The third-party server 20 acquires, based on this request, the other-user operation information from the organization database, and transmits the other-user operation information to the operation support server 10. The work information acquisition module 101 acquires the transmitted other-user operation information.

In Modification Example 3, the processing steps after the work information acquisition module 101 acquires the other-user operation information may be the same as those of Modification Example 2. For example, the operation support information acquisition module 102 acquires the operation support information output from the AI by inputting the other-user operation information to which access by the user is restricted to the AI together with the default prompt. The default prompt may include a wording that instructs to output the operation support information by altering content relating to privacy included in the other-user operation information. In this way, the AI can generate operation support information that does not include content touching on privacy of other users in accordance with the default prompt. The processing steps after the operation support information is acquired may be the same as those of the at least one embodiment. That is, the processing of the operation support information providing module 103 in Modification Example 3 may be the same as that of the at least one embodiment.

The operation support system 1 according to Modification Example 3 acquires the other-user operation information to which access by the user is restricted. As a result, the operation support system 1 can provide the operation support information to the user while protecting privacy of other users. For example, the user can perform an operation on the work screen SC1 with reference to the operation support information generated by the AI without knowing content touching on privacy of other users.

### [6-4. Modification Example 4]

For example, when the user does not perform an appropriate operation from the work screen SC1, an error may occur on the work screen SC1. In this case, the user may search a help page of the work support service to consider a method for resolving the error, but this case requires time and effort of the user. In view of this, in Modification Example 4, a case in which an operation of the user is supported by the AI generating operation support information corresponding to an error that has occurred on the work screen SC1 is taken as an example. In Modification Example 4, occurrence error information relating to an error that has occurred on the work screen SC1 is described as an example of the work information.

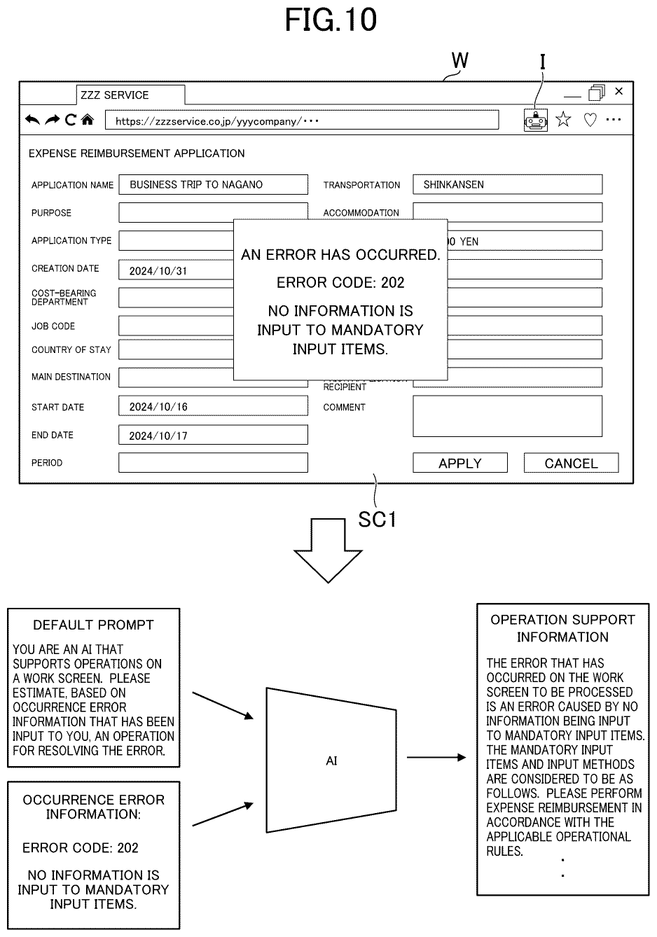

FIG. 10 includes a view for illustrating an example of an error that has occurred on the work screen SC1 and a diagram for illustrating an example of AI inputs and an AI output in Modification Example 4. In Modification Example 4, the third-party server 20 stores an error condition under which an error occurs on the work screen SC1. The error condition is a condition indicating whether or not an operation on the work screen SC1 is a predetermined operation. For example, the error condition indicates that an error occurs when information is not input to a mandatory input item. The error condition indicates that an error occurs when input is not performed by an input method defined for each individual input item. The error condition may be another condition such as a limit on the number of characters for an input form. When an error occurs, the work on the work screen SC1 is not completed.

For example, when a plurality of errors occur on the work screen SC1, the third-party server 20 may store an error code capable of identifying each error and an error condition of the error in association with each other. The third-party server 20 acquires information indicating content of the operation of the user on the work screen SC1 from the user terminal 40, and determines whether or not the error condition is satisfied. When it is determined that the error condition is satisfied, the third-party server 20 displays, on the work screen SC1, specific content of the error that has occurred as in the upper half of FIG. 10. The occurrence of the error may be determined by a method adopted in a publicly-known work support service, and is not limited to the example of Modification Example 4.

When an error occurs on the work screen SC1, the work information acquisition module 101 in Modification Example 4 acquires, as the work information, the occurrence error information relating to the error that has occurred on the work screen SC1. The occurrence error information indicates specific content of the error. For example, the occurrence error information indicates at least one of an error code indicating a type of the error that has occurred or text indicating specific content of the error. The occurrence error information may indicate other information such as a method of resolving the error. The occurrence error information may be any information that enables the AI to recognize the error that has occurred on the work screen SC1.

For example, in a case in which the extension of the browser is used in the same manner as in the at least one embodiment, when the user selects the icon I and the extension of the browser is activated, the user terminal 40 transmits the occurrence error information acquired from the third-party server 20 at a time of occurrence of the error to the operation support server 10. The work information acquisition module 101 acquires the occurrence error information from the user terminal 40. The work information acquisition module 101 may acquire the occurrence error information from another computer such as the third-party server 20 instead of the user terminal 40.

The operation support information acquisition module 102 in Modification Example 4 acquires the operation support information based on the occurrence error information and the AI. For example, as illustrated in FIG. 10, the operation support information acquisition module 102 inputs the default prompt and the occurrence error information to the AI as the input information. The occurrence error information may be embedded in the default prompt. The default prompt in Modification Example 4 includes a wording that instructs to generate operation support information based on the occurrence error information. This wording may be any wording that means that the operation support information is to be generated based on the occurrence error information, and is not limited to the example of FIG. 10. The default prompt may include a wording that instructs estimation of a method of resolving the error indicated by the occurrence error information.

For example, the operation support information acquisition module 102 inputs the default prompt and the occurrence error information to the AI by transmitting those pieces of information to the AI server 30. When the AI server 30 acquires the default prompt and the occurrence error information from the operation support server 10, the AI server 30 inputs those pieces of information as the input information to the AI stored in the AI server 30. When the actual data of the AI is stored in the data storage unit 100, the operation support information acquisition module 102 may input the default prompt and the occurrence error information to the AI stored in the data storage unit 100 without communicating to and from an external computer.

For example, the AI calculates an embedded representation of the default prompt and the occurrence error information that have been input to the AI based on parameters adjusted by pre-training. The AI may divide the default prompt and the occurrence error information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt and the occurrence error information are divided into tokens, the AI generates and outputs operation support information corresponding to a sequence of the embedded representations of the individual tokens.

In the example of FIG. 10, the AI estimates appropriate content as an input item and an input method for resolving the error specified by the default prompt, and outputs the estimated content as the operation support information. When the occurrence error information indicates a cause of the error, the AI estimates an input item and an input method for resolving the cause indicated in the occurrence error information, and outputs the operation support information indicating the estimation result. The operation support information acquisition module 102 acquires the operation support information output from the AI. In Modification Example 4, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

In Modification Example 4 as well, in the same manner as in the at least one embodiment, when the AI is specialized for the task of generating operation support information, the default prompt is not required to be input to the AI. When the user inputs the prompt by himself or herself, the default prompt is not required to be input to the AI. In Modification Example 4, the processing steps after the operation support information is acquired may be the same as those of the at least one embodiment. That is, the processing of the operation support information providing module 103 in Modification Example 4 may be the same as that of the at least one embodiment.

The operation support system 1 according to Modification Example 4 acquires the occurrence error information as the work information when an error occurs on the work screen SC1. The operation support system 1 acquires the operation support information based on the occurrence error information and the AI. As a result, the operation support system 1 can provide the user with the operation support information corresponding to the error that has occurred on the work screen SC1, and hence flexible operation support corresponding to the error can be performed. For example, the user can perform an operation for resolving the error with reference to the operation support information.

### [6-5. Modification Example 5]

For example, in the at least one embodiment, the case in which the HTML data of the work screen SC1 is acquired as the work information has been taken as an example, but a screenshot of the work screen SC1 may be used instead of the HTML data of the work screen SC1. The work information acquisition module 101 in Modification Example 5 acquires screenshot information relating to a screenshot of the work screen SC1 as the work information. The screenshot information is an image showing the screenshot of the work screen SC1. The image may be in any format processable by the AI. For example, the screenshot information may be in a JPEG format, a PNG format, a GIF format, or another format. The screenshot information may be acquired by a function installed in an operating system of the user terminal 40, or may be acquired by another publicly-known function.

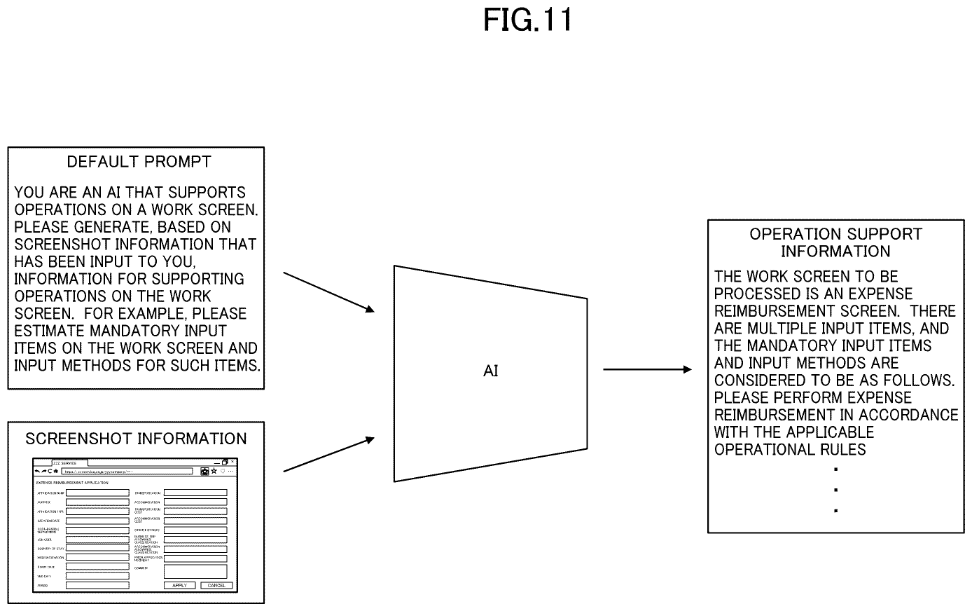

FIG. 11 is a diagram for illustrating an example of AI inputs and an AI output in Modification Example 5. As illustrated in FIG. 11, the work information acquisition module 101 acquires the screenshot information from the user terminal 40. In a case in which the extension of the browser is used in the same manner as in the at least one embodiment, when the user selects the icon I and the extension of the browser is activated, the user terminal 40 acquires the screenshot information of the work screen SC1 based on a publicly-known screenshot function. The user terminal 40 transmits the screenshot information to the operation support server 10. The work information acquisition module 101 acquires the screenshot information from the user terminal 40. When Modification Examples 4 and 5 are combined, the screenshot information may indicate a screenshot of the work screen SC1 at the time of the occurrence of the error in the upper half of FIG. 10.

The operation support information acquisition module 102 in Modification Example 5 acquires the operation support information based on the screenshot information and the AI. For example, as illustrated in FIG. 11, the operation support information acquisition module 102 inputs the default prompt and the screenshot information to the AI as the input information. The screenshot information may be embedded in the default prompt by a tag. The default prompt in Modification Example 5 includes wording that instructs to generate operation support information based on the screenshot information. This wording may be any wording that means that the operation support information is to be generated based on the screenshot information, and is not limited to the example of FIG. 11.

It is assumed that the AI in Modification Example 5 is a multi-modal AI capable of processing text and an image. When the default prompt in a text format and the screenshot information in an image format are input to the multi-modal AI, the operation support information acquisition module 102 can acquire the operation support information generated by the AI. The AI in Modification Example 5 may be a single-modal AI capable of processing only text. In this case, the operation support information acquisition module 102 may execute optical character recognition on the screenshot information to acquire text, and then input the default prompt and the text acquired from the screenshot information to the AI.

For example, the operation support information acquisition module 102 inputs the default prompt and the screenshot information to the AI by transmitting those pieces of information to the AI server 30. When the AI server 30 acquires the default prompt and the screenshot information from the operation support server 10, the AI server 30 inputs those pieces of information as the input information to the AI stored in the AI server 30. When the actual data of the AI is stored in the data storage unit 100, the operation support information acquisition module 102 may input the default prompt and the screenshot information to the AI stored in the data storage unit 100 without communicating to and from an external computer.

For example, the AI calculates an embedded representation of the default prompt and the screenshot information that have been input to the AI based on parameters adjusted by pre-training. An embedded representation of an image may be calculated by publicly-known processing such as convolution. The embedded representation of an image is sometimes referred to as “feature map.” The AI may divide the default prompt and the screenshot information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt and the screenshot information are divided into tokens, the AI generates and outputs operation support information corresponding to a sequence of the embedded representations of the individual tokens.

In the example of FIG. 11, the AI estimates appropriate content as the input items and input methods specified by the default prompt, and outputs the estimated content as the operation support information. When the screenshot information indicates mandatory input items and input methods for the input items, the AI outputs the operation support information indicating the input items and input methods of the work screen SC1 indicated in the screenshot information. The operation support information acquisition module 102 acquires the operation support information output from the AI. In Modification Example 5, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

In Modification Example 5 as well, in the same manner as in the at least one embodiment, when the AI is specialized for the task of generating operation support information, the default prompt is not required to be input to the AI. When the user inputs the prompt by himself or herself, the default prompt is not required to be input to the AI. In this case, the AI may be a single-modal AI capable of processing only an image. The AI may output the operation support information corresponding to an embedded representation of the screenshot information in an image format input to the AI. In Modification Example 5, the processing steps after the operation support information is acquired may be the same as those of the at least one embodiment. That is, the processing of the operation support information providing module 103 in Modification Example 5 may be the same as that of the at least one embodiment.

The operation support system 1 according to Modification Example 5 acquires the screenshot information as the work information. The operation support system 1 acquires the operation support information based on the screenshot information and the AI. The operation support system 1 can improve the accuracy of the operation support information by acquiring the operation support information based on the screenshot information indicating the work screen SCI. For example, the operation support system 1 can further improve the accuracy of the operation support information by acquiring the operation support information corresponding to the configuration of the work screen SC1 indicated in the screenshot information.

### [6-6. Modification Example 6]

For example, when the user is hesitant about an operation on the work screen SC1, providing the operation support information described in the at least one embodiment and Modification Examples 1 to 5 is effective in supporting the operation for the user. Thus, in Modification Example 6, a case in which the operation support information is automatically provided when it is determined that the user is hesitant about an operation on the work screen SC1 even before the user performs any explicit operation such as selecting the icon I is taken as an example.

The operation support system 1 according to Modification Example 6 includes the operation determination module 104. The operation determination module 104 determines, based on information received from the user terminal 40, whether or not the user is hesitant about an operation on the work screen SC1. Whether or not the user is hesitant about an operation on the work screen SC1 may be determined based on a predetermined determination method. For example, when a state in which no operation is performed on the work screen SC1 continues for a predetermined time or more, the user terminal 40 transmits user hesitation information indicating that the user is hesitant about an operation to the operation support server 10.

When a mouse pointer displayed on the work screen SC1 makes a predetermined movement, the user terminal 40 may transmit the user hesitation information indicating that the user is hesitant about an operation to the operation support server 10. When a focus state or input content for an input form on the work screen SC1 satisfies a predetermined condition (for example, that information is not input even after a predetermined time has elapsed from focus, or that input and deletion of information are repeated a predetermined number of times or more), the user terminal 40 may transmit the user hesitation information indicating that the user is hesitant about an operation to the operation support server 10. The user terminal 40 does not transmit the user hesitation information when the predetermined condition is not satisfied. The user terminal 40 may execute the above-mentioned processing based on the script of the work screen SC1, or may execute the above-mentioned processing based on another program different from the script.

For example, the operation determination module 104 determines whether or not the user is hesitant about an operation by determining whether or not the user hesitation information has been acquired from the user terminal 40. The operation determination module 104 determines that the user is not hesitant about an operation when the user hesitation information is not acquired from the user terminal 40, and determines that the user is hesitant about an operation when the user hesitation information is acquired from the user terminal 40. Instead of acquiring the user hesitation information from the user terminal 40, the operation determination module 104 may acquire operation content information indicating content of the operation of the user from the user terminal 40, and determine whether or not the user is hesitant about an operation based on the operation content information.

In Modification Example 6, processing of each of the work information acquisition module 101, the operation support information acquisition module 102, and the operation support information providing module 103 is executed when the operation determination module 104 determines that the user is hesitant about an operation on the work screen SC1. That is, the processing of each of the work information acquisition module 101, the operation support information acquisition module 102, and the operation support information providing module 103 is executed on condition (trigger) that the operation determination module 104 determines that the user is hesitant about an operation on the work screen SC1. The processing of each of the work information acquisition module 101, the operation support information acquisition module 102, and the operation support information providing module 103 is not executed when the operation determination module 104 does not determine that the user is hesitant about an operation on the work screen SC1.

For example, when the operation determination module 104 determines that the user is hesitant about an operation on the work screen SC1, the work information acquisition module 101 requests the user terminal 40 or another computer (for example, the third-party server 20) to transmit the work information described as an example in the at least one embodiment and Modification Examples 1 to 5. The user terminal 40 or the another computer transmits, based on this request, the work information to the operation support server 10. The work information acquisition module 101 acquires the transmitted work information. When the work information is stored in the data storage unit 100 or an information storage medium, the work information acquisition module 101 may acquire the work information from the data storage unit 100 or the information storage medium when the operation determination module 104 determines that the user is hesitant about an operation on the work screen SC1. The processing steps of each of the operation support information acquisition module 102 and the operation support information providing module 103 after the work information is acquired may be the same as those of the at least one embodiment and Modification Examples 1 to 5.

The operation support system 1 according to Modification Example 6 determines whether or not the user is hesitant about an operation on the work screen SC1 based on information received from the user terminal 40. The processing of each of the work information acquisition module 101, the operation support information acquisition module 102, and the operation support information providing module 103 is executed when the operation determination module 104 determines that the user is hesitant about an operation on the work screen SC1. As a result, the operation support system 1 can provide the operation support information to a user who is hesitant about an operation on the work screen SC1. For example, even when the user does not perform an explicit operation such as selecting the icon I, the operation support system 1 can provide the operation support information to the user, thereby enabling an increase in convenience of the user. When the operation support information is provided even though the user is not hesitant about an operation, the user may feel burdened, but the operation support system 1 can prevent the user from feeling burdened.

### [6-7. Modification Example 7]

For example, the user may explicitly input a prompt to the AI. The input of the prompt from the user may be performed on the work screen SC1, but in Modification Example 7, a case in which the input of the prompt from the user is performed on an online-chat screen different from the work screen SC1 is taken as an example. The operation support system 1 according to Modification Example 7 includes the display control module 105. The display control module 105 displays any screen on the user terminal 40. For example, the display control module 105 displays, on the user terminal 40, an online-chat screen for the user to perform online chat. The online-chat screen is a screen for the user to interact with another user or the AI.

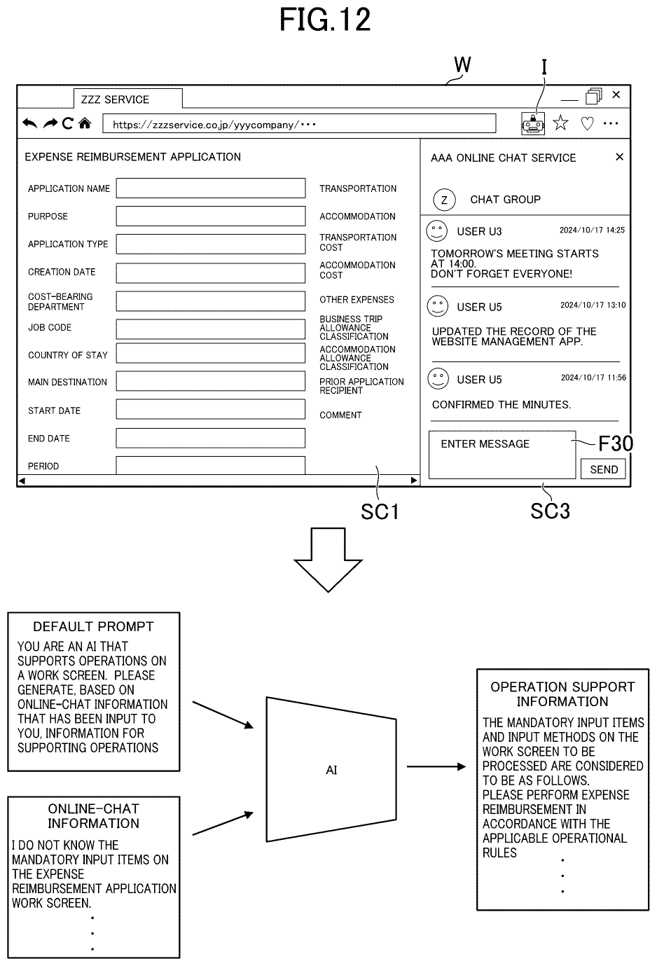

FIG. 12 includes a view for illustrating an example of the online-chat screen and a diagram for illustrating an example of AI inputs and an AI output in Modification Example 7. In the example of FIG. 12, the display control module 105 displays an online-chat screen SC3 on the user terminal 40 based on the extension of the browser. For example, when the user selects the icon I and the extension of the browser is activated, the user terminal 40 starts communication to and from the operation support server 10. When the operation support server 10 starts communication to and from the user terminal 40, the display control module 105 transmits display data (for example, HTML data) of the online-chat screen SC3 to the user terminal 40. The display data of the online-chat screen SC3 may be stored in the data storage unit 100.

In the example of FIG. 12, the display control module 105 displays the online-chat screen SC3 on the user terminal 40 based on a function called a side panel of the browser. The online-chat screen SC3 is displayed in the window W side by side with the work screen SC1. In the example of FIG. 12, the online-chat screen SC3 is arranged to the right of the work screen SC1, but the online-chat screen SC3 may be arranged below, to the left of, or above the work screen SC1. The display control module 105 may display the online-chat screen SC3 in a new window W or a new tab instead of the side panel. The online-chat screen SC3 includes an input form F30 capable of receiving input of any message. The online-chat screen SC3 also includes content of messages input in the past.

For example, the user may perform work while viewing the work screen SC1 and performing online chat with another user on the online-chat screen SC3. In Modification Example 7, the user inputs a prompt to the AI into the input form F30. In order for the user to explicitly indicate that the prompt to the AI is to be input, a button indicating that such a prompt is to be input may be displayed on the online-chat screen SC3, or the AI may be mentioned by “@AI” or the like. When the user performs such an explicit operation, the operation support server 10 may determine that the message input by the user is a prompt, and acquire the message input by the user as the work information. Instead of the mention, when a word such as “AI” is included in the message, the message may be determined to be a prompt, or whether or not the message is a prompt may be determined by the AI.

The work information acquisition module 101 in Modification Example 7 acquires, as the work information, online-chat information relating to content of online chat input by the user on the online-chat screen. The online-chat information is specific content of a message input by the user. In the example of FIG. 12, the online-chat information indicates text input into the input form F30. For example, when the user inputs a message into the input form F30, the user terminal 40 transmits the online-chat information indicating content of the message to the operation support server 10. The work information acquisition module 101 acquires the online-chat information from the user terminal 40. When the user inputs a message that is not a prompt to the AI (for example, a message to another user), generation of operation support information by the AI is not executed, and the message is reflected in the online chat.

The operation support information acquisition module 102 in Modification Example 7 acquires the o support information based on the online-chat information and the AI. For example, as illustrated in FIG. 12, the operation support information acquisition module 102 inputs the default prompt and the online-chat information to the AI as the input information. The online-chat information may be embedded in the default prompt. The default prompt in Modification Example 7 includes a wording that instructs to generate operation support information based on the online-chat information. This wording may be any wording that means that the operation support information is to be generated based on the online-chat information, and is not limited to the example of FIG. 12. The online-chat information may include information of input items on the work screen SC1, or an example of the work information described in the at least one embodiment and Modification Examples 1 to 5 (for example, the work screen display information in the at least one embodiment) may also be input to the AI so as to cope with a case in which the user does not particularly input the information of input items as a message.

For example, the operation support information acquisition module 102 inputs the default prompt and the online-chat information to the AI by transmitting those pieces of information to the AI server 30. When the AI server 30 acquires the default prompt and the online-chat information from the operation support server 10, the AI server 30 inputs those pieces of information as the input information to the AI stored in the AI server 30. When the actual data of the AI is stored in the data storage unit 100, the operation support information acquisition module 102 may input the default prompt and the online-chat information to the AI stored in the data storage unit 100 without communicating to and from an external computer.

For example, the AI calculates an embedded representation of the default prompt and the online-chat information that have been input to the AI based on parameters adjusted by pre-training. The AI may divide the default prompt and the online-chat information into units called tokens, and then calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt and the online-chat information are divided into tokens, the AI generates and outputs operation support information corresponding to a sequence of the embedded representations of the individual tokens.

In the example of FIG. 12, the AI estimates appropriate content as the input items and input methods specified by the online-chat information, and outputs the estimated content as the operation support information. The operation support information acquisition module 102 acquires the operation support information output from the AI. In Modification Example 7, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

In Modification Example 7, the user inputs the prompt by himself or herself, and hence the default prompt is not required to be input to the AI. In the same manner as in the at least one embodiment, when the AI is specialized for the task of generating operation support information, the default prompt is not required to be input to the AI. In Modification Example 7, the processing steps after the operation support information is acquired may be the same as those of the at least one embodiment. That is, the processing of the operation support information providing module 103 in Modification Example 7 may be the same as that of the at least one embodiment.

The operation support system 1 according to Modification Example 7 displays the online-chat screen SC3 on the user terminal 40. The operation support system 1 acquires, as the work information, the online-chat information relating to content of online chat input by the user on the online-chat screen SC3. The operation support system 1 acquires the operation support information based on the online-chat information and the AI. As a result, the operation support system 1 can acquire the operation support information corresponding to the online-chat information that more directly reflects a request of the user, and hence the accuracy of the operation support information can be improved.

### [6-8. Modification Example 8]

For example, the operation support information may be provided on the online-chat screen SC3. The operation support system 1 according to Modification Example 8 includes the display control module 105. The display control module 105 may be the same as that of Modification Example 7. In Modification Example 8, in the same manner as in Modification Example 7, the online-chat information may be acquired as the work information, or the online-chat information may not be acquired as the work information. That is, in Modification Example 8, in the same manner as in Modification Example 7, the online-chat information may be input to the AI, or the online-chat information may not be input to the AI. An aspect in which the AI generates operation support information without being based on the online-chat information is also within the scope of Modification Example 8. For example, in Modification Example 8, instead of inputting the online-chat information to the AI, the work information described as an example in the at least one embodiment and Modification Examples 1 to 6 may be input to the AI.

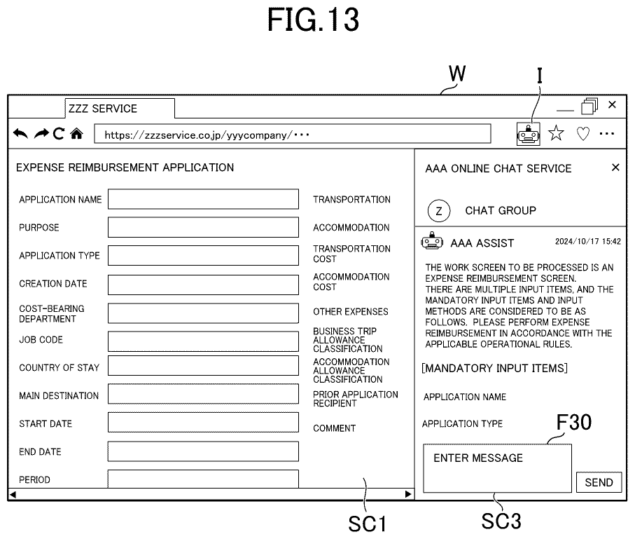

FIG. 13 is a view for illustrating an example of the online-chat screen SC3 in Modification Example 8. As illustrated in FIG. 13, the operation support information providing module 103 in Modification Example 8 provides the operation support information to the user by displaying the operation support information on the online-chat screen SC3 displayed on the user terminal 40. In Modification Example 8, the operation support information providing module 103 may be one function of the display control module 105. For example, the operation support information providing module 103 provides the operation support information to the user by displaying the operation support information on the online-chat screen SC3 arranged side by side with the work screen SC1 in one window W.

For example, the operation support information providing module 103 may display the operation support information on the online-chat screen SC3 by transmitting HTML data of the online-chat screen SC3 including the operation support information to the user terminal 40. The operation support information providing module 103 may display the operation support information on the online-chat screen SC3 by transmitting the operation support information in a data format different from HTML data to the user terminal 40. The data format may be a publicly-known data format that enables some information to be displayed on the user terminal 40. The operation support information providing module 103 may display the operation support information on the online-chat screen SC3 as a remark from the AI.

In the example of FIG. 13, the AI is indicated as a speaker of the online chat. The operation support information providing module 103 may display the operation support information in a speech balloon indicating a remark of the AI on the online-chat screen SC3. The user may input a message of a question to the AI from the online-chat screen SC3. In this case, the work information acquisition module 101 may acquire, as the work information, the online-chat information indicating the question input by the user. In the same manner as in Modification Example 7, the operation support information acquisition module 102 may acquire new operation support information by inputting the online-chat information to the AI. The operation support information acquisition module 102 may further input the acquired operation support information to the AI to acquire new operation support information.

The operation support system 1 according to Modification Example 8 displays, on the user terminal 40, the online-chat screen SC3 for the user to perform online chat. The operation support system 1 provides the operation support information to the user by displaying the operation support information on the online-chat screen SC3 displayed on the user terminal 40. As a result, the user can view the operation support information while performing online chat on the online-chat screen SC3, and hence the operation support system 1 can increase the convenience of the user. For example, when the online-chat screen SC3 is arranged side by side with the work screen SC1 as illustrated in FIG. 13, the user can view the operation support information on the online-chat screen SC3 while viewing the work screen SC1, and hence the operation support system 1 can further increase the convenience of the user.

### [6-9. Modification Example 9]

For example, the input information to be input to the AI is not limited to the work information described as an example in the at least one embodiment and Modification Examples 1 to 8. Other information different from the work information may be input to the AI. The other information to be input to the AI is hereinafter referred to as “other-input information.” The other-input information is information to be input to the AI together with the work information. The other-input information may be combined with the work information into one and input to the AI, or may be input to the AI separately from the work information.

The operation support system 1 according to Modification Example 9 includes the other-input information acquisition module 106. The other-input information acquisition module 106 acquires the other-input information, which is other information different from the work information, and is to be input to the AI. The other-input information may be any information that may be helpful for supporting operations on the work screen SC1. For example, the other-input information may be information other than information being displayed on the work screen SC1 in the work support service. In Modification Example 9, a case in which a kind of database called an app is displayed on the work screen SC1, and information registered in another app different from the app being displayed on the work screen SC1 corresponds to the other-input information is taken as an example.

For example, the other-input information may indicate a post made to a communication tool such as conversation threading. The other-input information may indicate content of work relating to the work screen SC1 among posts input by other users. The other-input information may indicate an attribute of the user. The attribute of the user is information capable of classifying the user from some viewpoint. For example, the attribute of the user may be an age, a year of joining the company, years of service, a department, a job position, or a role of the user, or a combination thereof. The other-input information may be information indicating an access right of the user to data relating to work on the work screen SC1.

For example, the other-input information may be stored in the third-party server 20. The other-input information acquisition module 106 acquires the other-input information stored in the third-party server 20 from the third-party server 20 or the user terminal 40. In Modification Example 9, when the user selects the icon I, the user terminal 40 acquires the other-input information, which is information registered in another application, from the third-party server 20. The user terminal 40 transmits the other-input information to the operation support server 10. The other-input information acquisition module 106 acquires the other-input information from the user terminal 40. When the other-input information is stored in another computer (for example, the operation support server 10) other than the third-party server 20 or an information storage medium, the other-input information acquisition module 106 may acquire the other-input information from the another computer or the information storage medium.

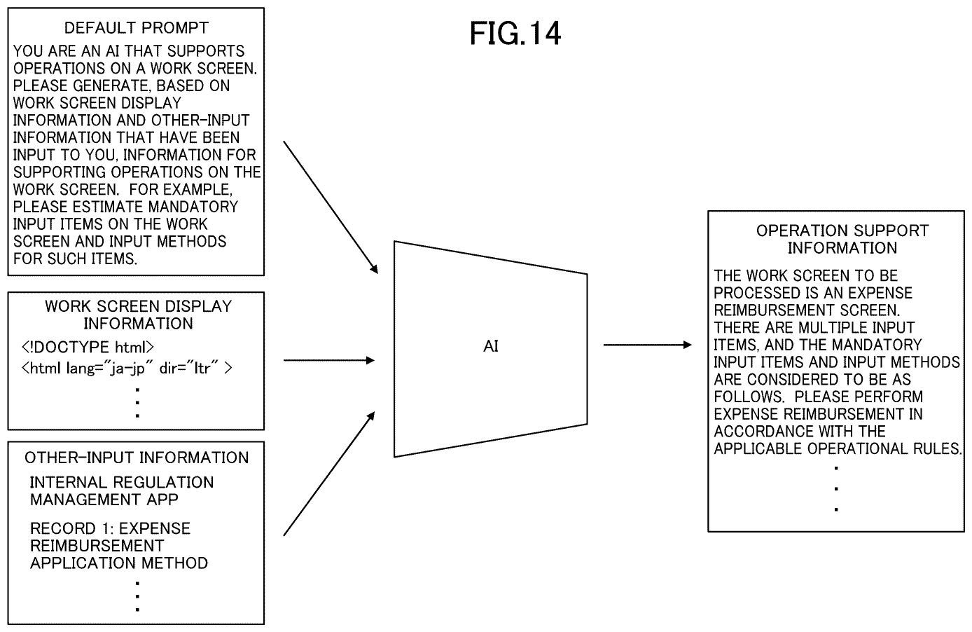

FIG. 14 is a diagram for illustrating an example of AI inputs and an AI output in Modification Example 9. The operation support information acquisition module 102 in Modification Example 9 acquires the operation support information based on the work information, the other-input information, and the AI. For example, as illustrated in FIG. 14, the operation support information acquisition module 102 inputs the default prompt, the work information, and the other-input information to the AI as the input information. The other-input information may be embedded in the default prompt. The default prompt in Modification Example 9 includes a wording that instructs to generate operation support information based on the other-input information. This wording may be any wording that means that the operation support information is to be generated based on the other-input information, and is not limited to the example of FIG. 14. In the example of FIG. 14, the other-input information indicates content of a record of an app in which data relating to internal regulations is registered. The AI estimates an operation to be performed by the user on the work screen SC1 while referring to the internal regulations.

For example, the operation support information acquisition module 102 inputs the default prompt, the work information, and the other-input information to the AI by transmitting those pieces of information to the AI server 30. When the AI server 30 acquires the default prompt, the work information, and the other-input information from the operation support server 10, the AI server 30 inputs those pieces of information as the input information to the AI stored in the AI server 30. When the actual data of the AI is stored in the data storage unit 100, the operation support information acquisition module 102 may input the default prompt, the work information, and the other-input information to the AI stored in the data storage unit 100 without communicating to and from an external computer.

For example, the AI calculates an embedded representation of the default prompt, the work information, and the other-input information that have been input to the AI based on parameters adjusted by pre-training. The AI may divide the default prompt, the work information, and the other-input information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt, the work information, and the other-input information are divided into tokens, the AI generates and outputs operation support information corresponding to a sequence of the embedded representations of the individual tokens.

In the example of FIG. 14, the AI estimates appropriate content as the input items and input methods specified by the default prompt, and outputs the estimated content as the operation support information. The AI outputs the operation support information based not only on the work information but also on the other-input information. As illustrated in FIG. 14, when internal regulations are indicated in the other-input information, the AI outputs the operation support information corresponding to content of the internal regulations. The operation support information acquisition module 102 acquires the operation support information output from the AI. In Modification Example 9, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

In Modification Example 9 as well, in the same manner as in the at least one embodiment, when the AI is specialized for the task of generating operation support information, the default prompt is not required to be input to the AI. When the user inputs the prompt by himself or herself, the default prompt is not required to be input to the AI. In Modification Example 9, the processing steps after the operation support information is acquired may be the same as those of the at least one embodiment. That is, the processing of the operation support information providing module 103 in Modification Example 9 may be the same as that of the at least one embodiment.

The operation support system 1 according to Modification Example 9 acquires the other-input information. The operation support system 1 acquires the operation support information based on the work information, the other-input information, and the AI. As a result, the operation support system 1 can acquire the operation support information based not only on the work information but also on the other-input information, and hence the accuracy of the operation support information can be improved.

### [6-10. Modification Example 10]

For example, the operation support information is not limited to the text described in the at least one embodiment and Modification Examples 1 to 9. The operation support information may be information other than text. In Modification Examples 10 to 12, other examples of the operation support information are described. The operation support information is a higher-level concept encompassing the examples described in the at least one embodiment and Modification Examples 1 to 12. The default prompt may indicate a type of the operation support information to be generated by the AI. When operation support information in a text format is generated as in the at least one embodiment and Modification Examples 1 to 9, the default prompt may include a wording indicating that the AI is to generate text.

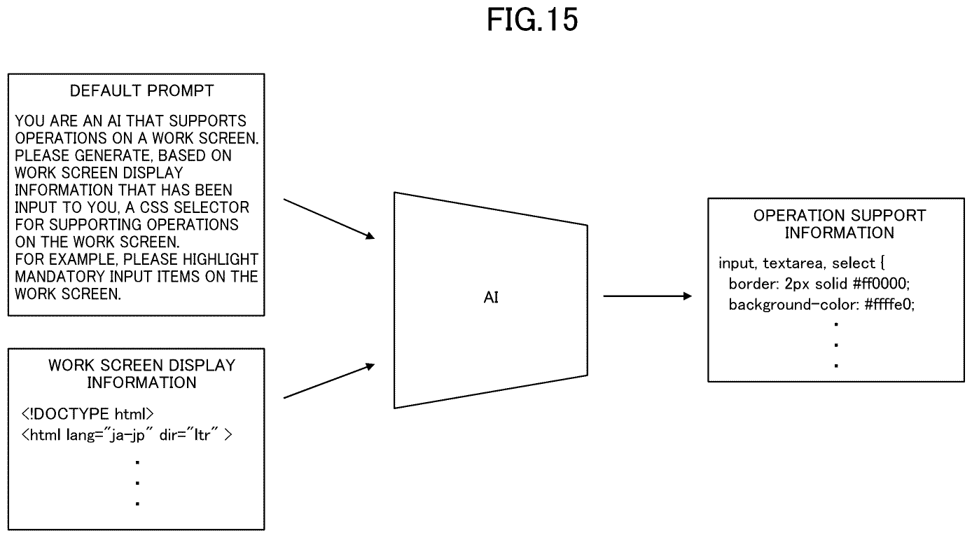

FIG. 15 is a diagram for illustrating an example of AI inputs and an AI output in Modification Example 10. In Modification Example 10, a case in which the operation support information acquisition module 102 acquires, as the operation support information, a cascading style sheets (CSS) selector that controls display of elements on the work screen SC1 is taken as an example. The CSS selector is code for applying a style to a specific element of HTML data. For example, the CSS selector includes code for changing a color, a size, a font, an attribute, an effect, or other appearance of an element of HTML data. The CSS selector is sometimes classified as a markup language.

The default prompt in Modification Example 10 includes a wording that instructs to generate a CSS selector based on the work information. For example, the default prompt indicates text such as “You are an AI that supports operations on a work screen. Please generate, based on work screen display information that has been input to you, a CSS selector for supporting operations on the work screen. For example, please highlight mandatory input items on the work screen.” The default prompt may be any wording indicating that a CSS selector is to be generated based on the work information, and is not limited to the example of FIG. 15.

For example, the AI recognizes that the AI itself is to generate a CSS selector as the operation support information based on an embedded representation of the default prompt. The AI estimates an operation to be performed by the user on the work screen SC1 based on another portion of the input information, and generates a CSS selector for highlighting a portion of the work screen SC1 corresponding to the operation as the operation support information. It is assumed that codes of various CSS selectors have been learned by the AI in advance as training data. Thus, the AI can generate a CSS selector based on input information that has been input to itself.

The operation support information providing module 103 in Modification Example 10 provides the CSS selector to the user as the operation support information. For example, the operation support information providing module 103 provides the CSS selector to the user by transmitting the CSS selector to the user terminal 40. The operation support information providing module 103 may transmit the HTML data of the work screen SC1 including the CSS selector to the user terminal 40. The CSS selector may be applied to the browser (work screen SC1) by any method. For example, the operation support information providing module 103 may apply the CSS selector to the work screen SC1 by an inline style, an internal style sheet, or an external style sheet in the HTML data of the work screen SC1.

For example, the operation support information providing module 103 highlights an input form of a mandatory input item in the work screen SC1 by applying the CSS selector to the work screen SC1. The input form may be highlighted by changing a color of the input form, changing a border of the input form, changing a size of the input form, applying an effect to the input form, or another method. The user inputs information required for work to the highlighted input form. The operation support information providing module 103 may display, on the work screen SC1, a message indicating that the highlighted input form is estimated as a mandatory input item by the AI. The user can easily recognize what operation to perform by the highlighting or the message.

The operation support system 1 according to Modification Example 10 acquires, as the operation support information, a CSS selector that controls display of elements on the work screen SC1. The operation support system 1 provides the CSS selector to the user as the operation support information. As a result, the user can refer to the operation support information, such as the CSS selector, which is visually easy to recognize, and hence the operation support system 1 can increase the convenience of the user.

### [6-11. Modification Example 11]

For example, the operation support information acquisition module 102 may acquire, as the operation support information, other-user information relating to another user appropriate as a person whom the user asks about an operation on the work screen SC1 among a plurality of other users belonging to the same organization as the organization to which the user belongs. The data storage unit 100 in Modification Example 11 stores a user database in which information on each of a plurality of users belonging to individual organizations is stored. Basic information such as personal information on the user is stored in the user database. For example, information of a login account, a password, a name, a department, or a role (work content) of the user is stored in the user database.

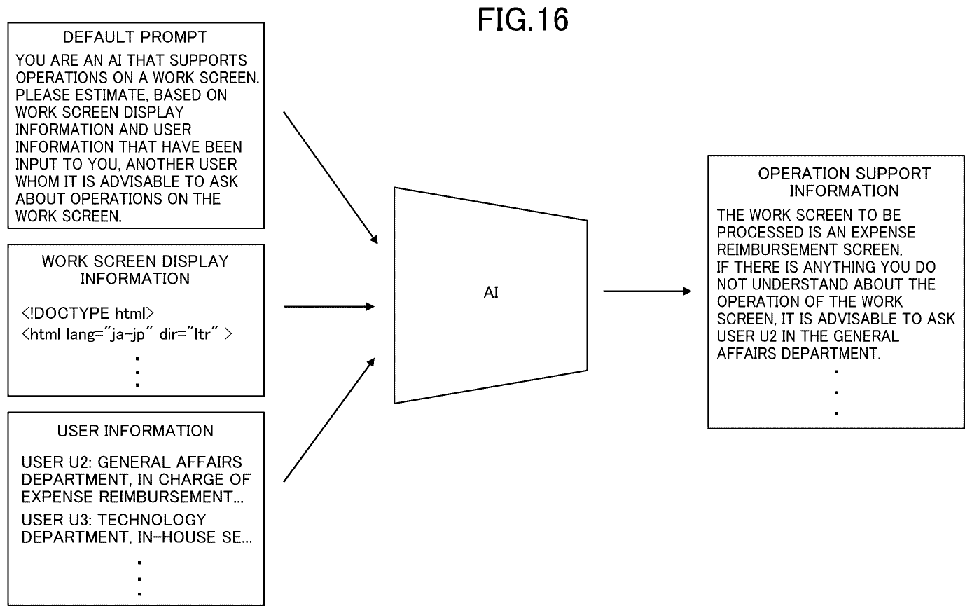

FIG. 16 is a diagram for illustrating an example of AI inputs and an AI output in Modification Example 11. The default prompt in Modification Example 11 includes a wording that instructs the AI to estimate another user appropriate as a person whom the user asks about an operation based on the work information and output the other-user information. This wording may be any wording that means that the other-user information is to be output, and is not limited to the example of FIG. 16. In the example of FIG. 16, the operation support information acquisition module 102 also inputs, to the AI, user information on each of a plurality of users belonging to the same organization as the organization to which the user belongs. The user information is a name, a department, a job position, or a role of the user, or a combination thereof. It is assumed that the user information is stored in the user database.

For example, as illustrated in FIG. 16, the operation support information acquisition module 102 inputs the default prompt, the work information, and the user information to the AI as the input information. The user information may be embedded in the default prompt. The default prompt in Modification Example 11 includes a wording that instructs to generate operation support information based on the user information. This wording may be any wording that means that the operation support information is to be generated based on the user information, and is not limited to the example of FIG. 16.

For example, the operation support information acquisition module 102 inputs the default prompt, the work information, and the user information to the AI by transmitting those pieces of information to the AI server 30. When the AI server 30 acquires the default prompt, the work information, and the user information from the operation support server 10, the AI server 30 inputs those pieces of information as the input information to the AI stored in the AI server 30. When the actual data of the AI is stored in the data storage unit 100, the operation support information acquisition module 102 may input the default prompt, the work information, and the user information to the AI stored in the data storage unit 100 without communicating to and from an external computer.

For example, the AI calculates an embedded representation of the default prompt, the work information, and the user information that have been input to the AI based on parameters adjusted by pre-training. The AI may divide the default prompt, the work information, and the user information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt, the work information, and the user information are divided into tokens, the AI generates and outputs operation support information corresponding to a sequence of the embedded representations of the individual tokens.

In the example of FIG. 16, the AI estimates a person appropriate as another user, which is specified by the default prompt, and outputs the estimated person as the operation support information. The operation support information acquisition module 102 acquires the operation support information output from the AI. In Modification Example 11, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

The operation support information providing module 103 in Modification Example 11 provides the other-user information to the user as the operation support information. Modification Example 11 is different from the at least one embodiment and Modification Examples 1 to 10 in that the other-user information corresponds to the operation support information, but other points are the same as those of the at least one embodiment and Modification Examples 1 to 10.

The operation support system 1 according to Modification Example 11 acquires the other-user information as the operation support information. In the operation support system 1, the operation support information providing module 103 provides the other-user information to the user as the operation support information. As a result, the user can know whom to ask about an operation on the work screen SC1, and hence the operation support system 1 can increase the convenience of the user.

### [6-12. Modification Example 12]

For example, the operation support information acquisition module 102 may acquire program code relating to support for operations as the operation support information. The program code may be code in any programming language executable on the user terminal 40. In Modification Example 12, a case in which code of a script executed on the browser corresponds to the program code is taken as an example, but program code that is not particularly executed on the browser may be acquired as the operation support information. The program code may be code for displaying an operation to be performed by the user on the work screen SC1, or may be code for automatically inputting an operation on the work screen SC1 on behalf of the user.

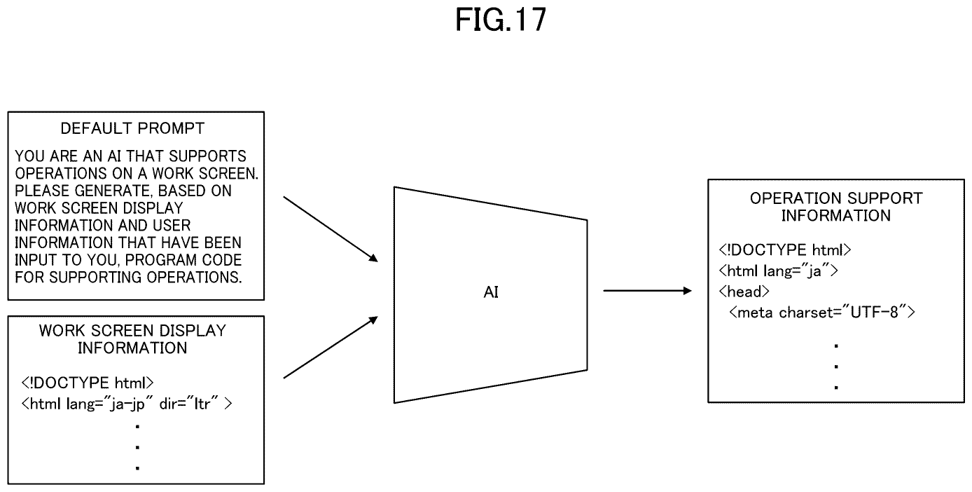

FIG. 17 is a diagram for illustrating an example of AI inputs and an AI output in Modification Example 12. The default prompt in Modification Example 12 includes a wording that instructs the AI to estimate program code appropriate to be executed on the user terminal 40 based on the work information and output the program code. The default prompt may indicate a programming language of the program code to be generated by the AI. As illustrated in FIG. 17, the operation support information acquisition module 102 inputs the default prompt and the work information to the AI as the input information. The default prompt may be any wording that means that program code for supporting the operation of the user on the work screen SC1 is to be generated based on the work information, and is not limited to the example of FIG. 17.

For example, the operation support information acquisition module 102 inputs the default prompt and the work information to the AI by transmitting those pieces of information to the AI server 30. When the AI server 30 acquires the default prompt and the work information from the operation support server 10, the AI server 30 inputs those pieces of information as the input information to the AI stored in the AI server 30. When the actual data of the AI is stored in the data storage unit 100, the operation support information acquisition module 102 may input the default prompt and the work information to the AI stored in the data storage unit 100 without communicating to and from an external computer. The AI recognizes that the AI itself is to generate program code as the operation support information based on an embedded representation of the default prompt.

For example, the AI calculates an embedded representation of the default prompt and the work information that have been input to the AI based on parameters adjusted by pre-training. The AI recognizes that the AI itself is to generate program code as the operation support information based on an embedded representation of a part of the default prompt, estimates content of an operation to be performed by the user based on the embedded representation of other parts of the default prompt and the work information, and generates program code for displaying the estimated content or program code for automatically inputting the estimated content. The AI may divide the default prompt and the work information into units called tokens, and calculate an embedded representation of each token. When the AI includes a plurality of intermediate layers, the AI may repeatedly calculate the embedded representation based on each individual intermediate layer. The AI generates and outputs operation support information corresponding to the embedded representation. When the default prompt and the work information are divided into tokens, the AI generates and outputs operation support information corresponding to a sequence of the embedded representations of the individual tokens.

In the example of FIG. 17, the AI estimates appropriate content as the program code specified by the default prompt, and outputs the estimated content as the operation support information. The operation support information acquisition module 102 acquires the operation support information output from the AI. In Modification Example 12, the AI system 3 manages the AI, and hence the AI server 30 transmits the operation support information to the operation support server 10. The operation support information acquisition module 102 acquires the operation support information from the AI server 30. When the actual data of the AI is stored in the data storage unit 100, the operation support information acquisition module 102 may acquire the operation support information without communicating to and from an external computer.

The operation support system 1 according to Modification Example 12 includes the execution feasibility determination module 107. The execution feasibility determination module 107 determines feasibility of execution of the program code based on a predetermined determination rule. For example, the execution feasibility determination module 107 determines whether or not a predetermined code is included in the program code. The predetermined code may be any code determined in advance. For example, the predetermined code may be code for transmitting information to an external server computer, code for deleting information stored in the user terminal 40, code for repeating predetermined processing, or other code.

For example, when the predetermined code is inappropriate code (when the inappropriate code is blacklisted in the determination rule), the execution feasibility determination module 107 may determine that the program code is executable when it is determined that the predetermined code is not included in the program code, and may determine that the program code is not executable when it is determined that the predetermined code is included in the program code. In contrast, when the predetermined code is appropriate code (when the appropriate code is whitelisted in the determination rule), the execution feasibility determination module 107 may determine that the program code is not executable when it is determined that the predetermined code is not included in the program code, and may determine that the program code is executable when it is determined that the predetermined code is included in the program code.

The operation support information providing module 103 in Modification Example 12 provides the program code to the user as the operation support information when the execution feasibility determination module 107 determines that execution of the program code is possible. The operation support information providing module 103 does not provide the program code to the user as the operation support information when the execution feasibility determination module 107 determines that execution of the program code is impossible. The operation Support information providing module 103 provides the program code to the user as the operation support information on condition that the execution feasibility determination module 107 determines that execution of the program code is possible. The user terminal 40 executes the provided program code, and displays or automatically inputs the operation content estimated by the AI. The display of the provision screen SC2 described in the at least one embodiment or the display of the online-chat screen SC3 described in Modification Example 8 may be executed based on the program code generated by the AI.

The operation support system 1 according to Modification Example 12 acquires, as the operation support information, the program code relating to support for operations. The operation support system 1 determines the feasibility of execution of the program code based on the predetermined determination rule. The operation support system 1 provides the program code to the user as the operation support information when the execution feasibility determination module 107 determines that execution of the program code is possible. As a result, the operation support system 1 can prevent program code that is not intended by the administrator of the operation support service or the user from being generated by the AI and executed on the user terminal 40.

### [6-13. Other Modification Examples]

For example, two or more of Modification Examples 1 to 12 may be combined.

For example, the functions described as being implemented by the operation support server 10 may be implemented by the user terminal 40. In this case, it suffices that the functions are implemented by a browser script or an application installed on the user terminal 40. In this case, the script or the application may correspond to the program according to the present disclosure. In this case, the operation support system 1 may include only the user terminal 40. For example, the respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An operation support system, comprising at least one processor configured to:
acquire work information relating to a work screen on which an operation relating to work of a user is defined, the work screen being displayed on a user terminal of the user;
acquire, based on the work information and an artificial intelligence (AI), operation support information relating to support for the operation on the work screen; and
provide the operation support information to the user.

2. The operation support system according to claim 1, wherein the at least one processor is configured to:
acquire the work information based on an extension of a browser of the user terminal when the work screen provided by a third-party system different from the operation support system is displayed on the browser; and
provide the operation support information to the user by transmitting the operation support information to one of the third-party system or the user terminal.

3. The operation support system according to claim 1, wherein the at least one processor is configured to:
acquire, as the work information, work screen display information for displaying the work screen on the user terminal; and
acquire the operation support information based on the work screen display information and the AI.

4. The operation support system according to claim 1, wherein the at least one processor is configured to:
acquire, as the work information, organization rule information relating to a rule relating to the work on the work screen, the rule being defined in an organization to which the user belongs; and
acquire the operation support information based on the organization rule information and the AI.

5. The operation support system according to claim 1, wherein the at least one processor is configured to:
acquire, as the work information, other-user operation information relating to an operation performed on the same screen as the work screen by another user belonging to the same organization as an organization to which the user belongs; and
acquire the operation support information based on the other-user operation information and the AI.

6. The operation support system according to claim 5, wherein the at least one processor is configured to acquire the other-user operation information to which access by the user is restricted.

7. The operation support system according to claim 1, wherein the at least one processor is configured to:
acquire, when an error occurs on the work screen, occurrence error information relating to the error that has occurred on the work screen as the work information; and
acquire the operation support information based on the occurrence error information and the AI.

8. The operation support system according to claim 1, wherein the at least one processor is configured to:
acquire screenshot information relating to a screenshot of the work screen as the work information; and
acquire the operation support information based on the screenshot information and the AI.

9. The operation support system according to claim 1, wherein the at least one processor is configured to:
determine, based on information received from the user terminal, whether the user is hesitant about the operation on the work screen; and
execute the acquiring of the work information, the acquiring of the operation support information, and the providing of the operation support information when it is determined that the user is hesitant about the operation on the work screen.

10. The operation support system according to claim 1, wherein the at least one processor is configured to:
display, on the user terminal, an online-chat screen for the user to perform online chat;
acquire, as the work information, online-chat information relating to content of the online chat input by the user on the online-chat screen; and
acquire the operation support information based on the online-chat information and the AI.

11. The operation support system according to claim 1, wherein the at least one processor is configured to:
display, on the user terminal, an online-chat screen for the user to perform online chat; and
provide the operation support information to the user by displaying the operation support information on the online-chat screen displayed on the user terminal.

12. The operation support system according to claim 1, wherein the at least one processor is configured to:
acquire other-input information, which is other information different from the work information, and is to be input to the AI; and
acquire the operation support information based on the work information, the other-input information, and the AI.

13. The operation support system according to claim 1, wherein the at least one processor is configured to:
acquire, as the operation support information, a cascading style sheets (CSS) selector that controls display of an element on the work screen; and
provide the CSS selector to the user as the operation support information.

14. The operation support system according to claim 1, wherein the at least one processor is configured to:
acquire, as the operation support information, other-user information relating to another user appropriate as a person whom the user asks about the operation among a plurality of other users belonging to the same organization as an organization to which the user belongs; and
provide the other-user information to the user as the operation support information.

15. The operation support system according to claim 1, wherein the at least one processor is configured to:
acquire program code relating to support for the operation as the operation support information;
determine feasibility of execution of the program code based on a predetermined determination rule; and
provide the program code to the user as the operation support information when it is determined that the execution of the program code is possible.

16. An operation support method, comprising:
acquiring work information relating to a work screen on which an operation relating to work of a user is defined, the work screen being displayed on a user terminal of the user;
acquiring, based on the work information and an artificial intelligence (AI), operation support information relating to support for the operation on the work screen; and
providing the operation support information to the user.

17. A non-transitory information storage medium having stored thereon a program for causing a computer to:
acquire work information relating to a work screen on which an operation relating to work of a user is defined, the work screen being displayed on a user terminal of the user;
acquire, based on the work information and an artificial intelligence (AI), operation support information relating to support for the operation on the work screen; and
provide the operation support information to the user.
